(19) United States
(12) Patent Application Publication
(10) Pub. No.: US 2010/0070958 A1
(43) Pub. Date: Mar. 18, 2010

(54) PROGRAM PARALLELIZING METHOD AND PROGRAM PARALLELIZING APPARATUS

(75) Inventor: Masamichi Takagi, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 12/449,160

(22) PCT Filed: Nov. 15, 2007
(86) PCT No.: PCT/JP2007/072185

§ 371 Date: Jul. 24, 2009

(30) Foreign Application Priority Data
Jan. 25, 2007 (JP) 2007-014525

(51) Int. Cl. G06F 9/45

(52) U.S. Cl. 717/149

(57) ABSTRACT

Provided is a program parallelizing method and a program parallelizing apparatus that enable to efficiently generate a parallelized program with shorter parallel execution time.

An instruction is scheduled by referring to inter-instruction dependency. A dependency between an instruction in a function fp/f0 and an instruction of a function fq of its descendant is analyzed, and parallelization is performed with the analysis result. First, an instruction of a deeper function fq is relatively scheduled to analyze whether each instruction has dependency with an instruction of another function fp. When there is inter-instruction dependency, scheduling of the instruction of the function fq is performed so as to maintain the dependency and realize the shortest execution time.

### TECHNICAL FIELD

The present invention relates to a technique for processing a sequential processing program with a parallel processor system in parallel, and more particularly, to a method and a device that generate a parallelized program from a sequential processing program.

### BACKGROUND ART

As a method of processing a single sequential processing program in parallel in a parallel processor system, there has been known a multi-threading method (see, for example, patent documents 1 to 5, non-patent documents 1 and 2). In the multi-threading method, a sequential processing program is divided into instruction streams called threads and executed in parallel by a plurality of processors. A parallel processor that executes multi-threading is called multi-threading parallel processor. In the following, a description will be given of conventional multi-threading methods first and then a related program parallelizing method.

### 1. Multi-Threading Method

Generally, in a multi-threading method in a multi-threading parallel processor, to create a new thread on another processor is called “forking”. A thread which executes a fork is referred to as “parent thread”, while a newly generated thread is referred to as “child thread”. The program location where a thread is forked is referred to as “fork source address” or “fork source point”. The program location at the beginning of a child thread is referred to as “fork destination address”, “fork destination point”, or “child thread start point”.

In the aforementioned patent documents 1 to 4 and the non-patent documents 1 to 2, a fork command is inserted at the fork source point to instruct the forking of a thread. The fork destination address is specified in the fork command. When the fork command is executed, child thread that starts at the fork destination address is created on another processor, and then the child thread is executed. A program location where the processing of a thread is to be ended is called a terminal (term) point, at which each processor finishes processing the thread.

FIGS. 1A to 1D each shows a schematic diagram for describing an outline of the processing conducted by a multi-threading parallel processor in a multi-threading method. FIG. 1A shows a single sequential processing program divided into three threads A, B, and C. When the program is processed in a single processor, one processor PE sequentially processes threads A, B, and C as shown in FIG. 1B.

### 1.1) Fork-One Model

In contrast, according to a multi-threading method in a multi-threading parallel processor, as shown in FIG. 10, thread A is executed by one processor PE1, and, while processor PE1 is executing thread A, thread B is generated on another processor PE2 by a fork command embedded in thread A, and thread B is executed by processor PE2. Processor PE2 generates thread C on processor PE3 by a fork command embedded in thread B. The processor PE1 finishes processing the thread at a terminal point in a position that corresponds to a boundary of the thread A and the thread B on an executable file. Similarly, the processor PE2 finishes processing the thread at a terminal point in a program location that corresponds to a boundary of the thread B and the thread C. Having executed the last command of thread C, processor PE3 executes the next command (usually a system call command). As just described, by concurrently executing threads in a plurality of processors, performance can be improved as compared with the sequential processing.

As shown in FIG. 1C, the multi-threading method that is restricted in such a manner that a thread can create a valid child thread only once while the thread is alive is called a fork-one model. The fork-one model substantially simplifies the management of threads. Consequently, a thread managing unit can be implemented by hardware of practical scale. Further, each processor can create a child thread on only one other processor, and therefore, multi-threading can be achieved by a parallel processor system in which adjacent processors are connected unidirectionally in a ring form.

There is another multi-threading method, as shown in FIG. 1D, in which forks are performed several times by the processor PE1 that is executing thread A to crate threads B and C on processors PE2 and PE3, respectively.

There is a commonly known method that can be used in the case where no processor is available on which to create a child thread when a processor is to execute a fork command. That is, the processor waits to execute the fork command until a processor on which a child thread can be created becomes available. Besides, as shown in the patent document 4, there is described another method in which the processor invalidates or nullifies the fork command to continuously execute instructions subsequent to the fork command and then executes instructions of the child thread.

To implement the multi-threading of the fork-one model, in which a thread creates a valid child thread at most once in its lifetime, for example, the technique disclosed in the non-patent document 1 places restrictions on the compilation for creating a parallelized program from a sequential processing program so that every thread is to be a command code to perform a valid fork only once. In other words, the fork-once limit is statically guaranteed on the parallelized program. On the other hand, according to the patent document 3, from a plurality of fork commands in a parent thread, one fork command to create a valid child thread is selected during the execution of the parent thread to thereby guarantee the fork-once limit at the time of program execution.

### 1.2) Pass Register Value

For a parent thread to create a child thread such that the child thread performs predetermined processing, the parent thread is required to pass to the child thread the value of a register, at least necessary for the child thread, in a register file at the fork point of the parent thread. To reduce the cost of data transfer between the threads, in the patent document 2 or the non-patent document 1, a register value inheritance mechanism used at thread creation is provided through hardware. With this mechanism, the contents of the register file of a parent thread is entirely copied into a child thread at thread creation. After the child thread is produced, the register values of the parent and child threads are changed or modified independently of each other, and no data is transferred therebetween through registers.

As another conventional technique concerning data passing between threads, there has been proposed a method as disclosed in the non-patent document 2. In this method, the register value inheritance mechanism is provided through hardware, and a required register value is transferred between threads when a child thread is generated and after the child thread is generated. Further alternatively, there has also been proposed a parallel processor system provided with a mechanism to individually transfer a register value of each register by a command.

### 1.3) Execute Thread Speculation

In the multi-threading method, basically, previous threads whose execution has been determined are executed in parallel. However, in actual programs, it is often the case that not enough threads can be obtained, whose execution has been determined. Additionally, the parallelization ratio may be low due to dynamically determined dependencies, limitation of the analytical capabilities of the compiler and the like, and desired performance cannot be achieved. Accordingly, in the patent document 1, control speculation is adopted to support the speculative execution of threads through hardware. In the control speculation, threads with a high possibility of execution are speculatively executed before the execution is determined. The thread in the speculative state is temporarily executed to the extent that the execution can be cancelled via hardware. The state in which a child thread performs temporary execution is referred to as temporary execution state. When a child thread is in the temporary execution state, a parent thread is said to be in the temporary thread creation state. In the child thread in the temporary execution state, writing to a shared memory and a cache memory is restrained, and data is written to a temporary buffer additionally provided.

When is confirmed that the speculation is correct, the parent thread sends a speculation success notification to the child thread. The child thread reflects the contents of the temporary buffer in the shared memory and the cache memory, and then returns to the ordinary state in which the temporary buffer is not used. The parent thread changes from the temporary thread creation to thread creation state.

On the other hand, when failure of the speculation is confirmed, the parent thread executes a thread abort command “abort” to cancel the execution of the child thread and subsequent threads. The parent thread changes from the temporary thread creation to non-thread creation state. Thereby, the parent thread can generate a child thread again. That is, in the fork-one model, although the thread creation can be carried out only once, if control speculation is performed and the speculation fails, a fork can be performed again. Also in this case, only one valid child thread can be produced.

### 2. Parallelize Program

A description will now be given of the technique to generate a parallel program for a parallel processor to implement the multi-threading.

FIG. 2A is a block diagram showing one example of a related program parallelizing apparatus. A program parallelizing apparatus 10 includes, for example, according to the functional configuration disclosed in the patent documents 7 and 8, a control/data flow analyzer 11 and a parallelization point determination unit 12. First, the control/data flow analyzer 11 analyzes the control flow and data flow of a sequential processing program 13 described in a high-level language. According to the analysis of the data flow, upon judgment of dependency between an instruction (I1) in a function and an instruction (I2) in another function called by the function, a function calling instruction C is scheduled to be executed after execution of the instruction I1 (see for example paragraph 0047 of the patent document 8). In other words, the dependency between the instruction I1 and the instruction I2 is approximated and is replaced with dependency between the instruction I1 and the function calling instruction C (description of the specific example will be made with reference to FIG. 3). Then, the parallelization point determination unit 12 determines in which processor each parallelization unit is executed with a basic block or a plurality of basic blocks as a unit of parallelization with reference to the analysis result such as the control flow and the data flow, so as to generate a parallelized program 14 divided into a plurality of threads.

FIG. 2B shows a block diagram showing another example of a related program parallelizing apparatus. A program parallelizing apparatus 20 includes, according to the functional configuration disclosed in the patent document 6, an instruction exchanging processing/instruction exchanging selecting unit 21, a fork point determining unit 22, and a fork inserting unit 23. First, in a step of exchanging the instruction sequences, a plurality of sequential processing programs are created in which a part of the instruction sequence of a sequential processing program 24 is changed to another instruction sequence, and they are compared with the sequential processing program 24, so as to select the sequential processing program with improved parallel execution performance (see for example paragraph 0100 of the patent document 6).

Then, in a fork point determining step, a combination of fork points indicating optimal parallel execution performance is determined with an iterative improvement method with respect to the selected sequential processing program (see for example paragraph 0154 of the patent document 6). At this time, the above-described inter-instruction dependency is maintained while changing only the combination of the fork points without performing exchange of the instruction sequences. This is, in other words, a technique in which the dependency is maintained by a unit of a plurality of instructions. This unit of a plurality of instructions corresponds to an element in which the sequential execution trace when the sequential processing program is sequentially executed by the input data is divided with all the terminal point candidates as a division point. Lastly, in a fork inserting step, a fork command for parallelization is inserted to generate a parallelized program 25 divided into a plurality of threads.
[Patent Document 1]
Japanese Unexamined Patent Application Publication No. 10-27108
[Patent Document 2]
Japanese Unexamined Patent Application Publication No. 10-78880
[Patent Document 3]
Japanese Unexamined Patent Application Publication No. 2003-029985
[Patent Document 4]
Japanese Unexamined Patent Application Publication No. 2003-029984
[Patent Document 5]
Japanese Unexamined Patent Application Publication No. 2001-282549
[Patent Document 6]
Japanese Unexamined Patent Application Publication No. 2006-018445
[Patent Document 7]
Japanese Patent No. 2749039
[Patent Document 8]
Japanese Unexamined Patent Application Publication No. 5-143357
[Non-patent Document 1]
“Proposal of On Chip Multiprocessor Oriented Control Parallelization Architecture MUSCAT” (Joint Symposium on Parallel Processing, JSPP97, Transactions of Information Processing Society of Japan, pp. 229-236, May 1997)
[Non-patent Document 2]
Taku Ohsawa, Masamichi Takagi, Shoji Kawahara, Satoshi Matsushita: Pinot: Speculative Multi-threading Processor Architecture Exploiting Parallelism Over a Wide Range of Granularities. In Proceedings of 38th MICRO, pp. 81-92, 2005.

### DISCLOSURE OF INVENTION

### Technical Problems

However, according to the related program parallelizing apparatus, the parallel execution time may not be shortened as is expected and the time required to determine the parallelized program is also made longer. This point will be described hereinafter in detail.

(1) According to the program parallelizing apparatus shown in FIG. 2A, the dependency between the instructions I1 and I2 is approximated by the dependency between the instruction I1 and the function calling instruction C, instead of employing the dependency between the instructions I1 and I2. As this technique does not consider the inter-instruction dependency, when there is a function calling instruction C, it is scheduled to be arranged after the instruction I1 to keep the dependency safe. As such, the schedule may be determined in which the parallel execution time becomes undesirably longer. This point will be described in detail with reference to FIGS. 3 and 4.

FIG. 3 is a diagram showing an internal representation of an intermediate program obtained by analyzing the sequential processing program. It is assumed, in FIG. 3, that the input program is formed of functions f1 and f2, the function f1 is formed of the instructions L1 to L3, and the function f2 is formed of instructions L4 to L6 for the sake of clarity. Further, the function f1 calls the instruction f2 by the function calling instruction L3 (L3: call f2). The execution will be started from the function f1.

In FIG. 3, the functions f1 and f2 are represented by nodes indicating functions. The function f1 is composed of basic blocks B1 and B2, the basic block B1 is composed of instructions L1 and L2, and the basic block B2 is composed of a calling instruction L3. Further, the function f2 is composed of a basic block B3, and the basic block B3 is composed of instructions L3, L4, and L5.

After execution of the basic block B1, the control moves to the basic block B2, where the function calling instruction L3 is executed, and thereafter the control moves to the basic block B3. This control flow will be shown by solid arrows. In this program, there is a dependency by the data flow in which the data (r3) defined by the instruction L1 is referred to by the instruction L2. Further, there is a dependency by the data flow in which the data (memory data stored in an address r2) defined by the instruction L2 is referred to by the instruction L5. When there is dependency by the data flow from one instruction X to one instruction Y, it is assumed that the instruction Y must be executed at a time obtained by adding an execution delay time to the execution time of the instruction X or later, and the execution delay time of all the instructions is one cycle.

FIGS. 4A and 4B are instruction allocation diagrams showing one example of the instruction schedule result obtained by the related program parallelizing apparatus. When the execution cycle and the execution processor of the instruction are to be determined without analyzing the inter-instruction dependency, the scheduling is performed as there is dependency from the instruction L2 to the instruction L3 so as to satisfy the condition of the data flow for safety. Even when there are plurality of processors as shown in FIG. 4A as a result of performing the instruction schedule using the safe approximation, the instructions L1 to L3 are ended up to be arranged on one processor in order to strictly maintain the dependency from the instruction L1 to the instruction L2 and the dependency from the instruction L2 to the instruction L3. Accordingly, time for six cycles is required for execution as shown in FIG. 4B. However, although the dependency from the instruction L2 to the instruction L5 needs to be maintained in this example, the dependency from the instruction L2 to the instruction L3 needs not be maintained. According to the related art, as the dependency is maintained by the safe approximation, there is a high capability that the unwantedly long parallel execution time is eventually produced.

The same thing can be said about a program parallelizing apparatus shown in FIG. 2B. According to the program parallelization, the instruction sequences are exchanged in order to ameliorate the parallel execution performance, the sequential processing program is selected so that the parallel execution time becomes the shortest, and optimal combination of fork points is determined by an iterative improvement method with respect to the selected sequential processing program. In this case, while the instruction sequences are exchanged so that the number of candidates of the fork point is increased in the step of exchanging the instruction sequences, only the fork point is changed without exchanging the instruction sequences in the step of searching the fork point combination to determine the optimal fork point set. Therefore, the inter-instruction dependency is maintained by a unit of a plurality of instructions. In summary, in the step of searching the fork point combination, the inter-instruction dependency is analyzed by a unit of a plurality of instructions, and there is high probability that the undesirably long parallel execution time is consequently produced similarly to the maintenance of the dependency by the approximation described above.

In summary, according to the related program parallelizing apparatus, since only a partial analysis is performed for an instruction in one function and an instruction of a function group of a descendant of the function in a function calling graph, a schedule in which the parallel execution time becomes undesirably long may be determined.

(2) The second problem of the related program parallelizing apparatus is that it takes longer time in the determination process when it is attempted to obtain a parallelized program with shorter parallel execution time. For example, there are two reasons for it in the program parallelizing apparatus shown in FIG. 2B. Firstly, as the number of available combinations of the fork points is extremely large, it takes longer time to determine a combination of the fork points with shorter parallel execution time among them. Secondly, in order to practice the iterative improvement method for determining the combination of the fork points with shorter parallel execution time, two steps of changing the combination of the fork points and measuring the parallel execution time need to be repeated.

The present invention has been made in view of such a circumstance, and an exemplary object of the present invention is to provide a program parallelizing method and a program parallelizing device that enable efficient generation of a parallelized program with shorter parallel execution time.

### Technical Solution

According to the present invention, parallelization of a program is performed by scheduling instructions by referring to inter-instruction dependency. In summary, inter-instruction dependency between a first instruction group including at least one instruction and a second instruction group including at least one instruction is analyzed, so as to execute instruction scheduling of the first instruction group and the second instruction group by referring to the inter-instruction dependency. The schedule whose execution time is shorter can be obtained by referring to the inter-instruction dependency.

According to one exemplary embodiment, when the first instruction group is correlated with a lower level of the second instruction group, the instruction scheduling of the first instruction group is executed, and thereafter the instruction scheduling of the second instruction group is executed by referring to the inter-instruction dependency. For example, this case includes when the second instruction group includes a calling instruction that calls for the first instruction group.

When the instruction scheduling of the second instruction group is executed after executing the instruction scheduling of the first instruction group, information of the inter-instruction dependency is preferably added to the calling instruction included in the second instruction group, and thereafter the instruction scheduling of the second instruction group is executed. This is because it is possible to refer to the inter-instruction dependency added to the calling instruction in scheduling the second instruction group.

According to another aspect of the present invention, each of the first instruction group and the second instruction group forms a strongly connected component including at least one function that includes at least one instruction. It is especially preferable to repeat analysis of the instruction dependency and the scheduling for a plurality of times for the strongly connected component of a form in which functions depend on each other. In summary, a) the instruction scheduling is executed for each function included in one strongly connected component, b) the instruction dependency with another function is analyzed for each function, and c) a) and b) are repeated with respect to each strongly connected component for a specified number of times set in accordance with a form of the strongly connected component.

According to one exemplary embodiment of the present invention, the execution cycle and the execution processor of the instruction are analyzed for dependency between an instruction in one function and an instruction of a function group of a descendant of the function in a function calling graph, and parallelization is performed with the analysis result. Accordingly, it is possible to realize parallel processing while keeping the dependency between an instruction in one function and an instruction of a function group of a descendant of the function, whereby the parallelized program with shorter parallel execution time can be generated.

### ADVANTAGEOUS EFFECTS

According to the present invention, the inter-instruction dependency is referred to schedule the instruction, whereby the schedule whose execution time is shorter can be obtained. For example, the dependency between an instruction in one function and an instruction of a function group of a descendant of the function in a function calling graph is analyzed to execute parallelization with the analysis result, whereby it is possible to instruct to execute an instruction in one function and an instruction of a function group of a descendant of the function in parallel.

Further, according to the present invention, the search for a combination of fork points is not performed in parallelization. The extremely large number of available candidates of the combination of the fork points makes it difficult to perform high-speed program parallelization as stated above. However, as the search of the combination of the fork points is not performed in the present invention, it is possible to generate the parallelized program with shorter parallel execution time in high speed.

### BRIEF DESCRIPTION OF DRAWINGS

FIG. 1A is a schematic diagram for describing an outline of processing of a multi-threading method in a multi-threading parallel processor;

FIG. 1B is a schematic diagram for describing an outline of processing of a multi-threading method in a multi-threading parallel processor;

FIG. 1C is a schematic diagram for describing an outline of processing of a multi-threading method in a multi-threading parallel processor;

FIG. 1D is a schematic diagram for describing an outline of processing of a multi-threading method in a multi-threading parallel processor;

FIG. 2A is a block diagram showing one example of a related program parallelizing apparatus;

FIG. 2B is a block diagram showing another example of the related program parallelizing apparatus;

FIG. 3 is a diagram showing an internal representation of an intermediate program obtained by analyzing a sequential processing program;

FIG. 4A is an instruction allocation diagram showing one example of an instruction schedule result obtained by a related program parallelizing apparatus;

FIG. 4B is an instruction allocation diagram showing one example of an instruction schedule result obtained by a related program parallelizing apparatus;

FIG. 5A is a schematic diagram showing one example of a function for describing a program parallelizing method according to a first exemplary embodiment of the present invention;

FIG. 5B is a flow chart showing a procedure of the program parallelizing method according to the first exemplary embodiment applied to the example shown in FIG. 5A;

FIG. 6 is a configuration diagram of an intermediate program indicated by an internal representation when functions f1 and f2 are processed by a program parallelizing apparatus;

FIG. 7A is a schematic diagram showing an allocation example of a schedule space for describing a procedure for parallelization according to the first exemplary embodiment;

FIG. 7B is a schematic diagram showing an allocation example of a schedule space for describing a procedure for parallelization according to the first exemplary embodiment;

FIG. 8 is a function calling graph for describing a strongly connected component;

FIG. 9 is a diagram showing one example of an input program for describing the strongly connected component;

FIG. 10 is a diagram showing a sequential processing intermediate program in accordance with the input program shown in FIG. 9;

FIG. 11 is a schematic block diagram showing the configuration of a program parallelizing apparatus according to a first exemplary example of the present invention;

FIG. 12 is a block diagram showing one example of a processing apparatus according to the first exemplary example;

FIG. 13 is a block diagram showing one example of a circuit that generates inter-instruction dependency information;

FIG. 14 is a flow chart showing the whole operation of dependency analysis and schedule processing processed by a dependency analyzing/instruction scheduling unit 102;

FIG. 15 is a flow chart showing a whole function internal/external dependency analyzing processing regarding a source;

FIG. 16 is a flow chart showing a detail of the function internal/external dependency analyzing processing regarding the source;

FIG. 17 is a flow chart showing a whole function internal/external dependency analyzing processing regarding a destination;

FIG. 18 is a flow chart showing a detail of the function internal/external dependency analyzing processing regarding the destination;

FIG. 19 is a diagram showing an input program before being converted to a sequential processing intermediate program;

FIG. 20A is a diagram showing a sequential processing intermediate program;

FIG. 20B is a diagram showing a function calling graph of the sequential processing intermediate program shown in FIG. 20A;

FIG. 21 is a diagram showing a relative schedule of a function f12;

FIG. 22 is a diagram showing the sequential processing intermediate program for describing the operation of a relative value added to a directed side in the dependency analyzing process;

FIG. 23 is a diagram showing a schedule determination process of an instruction L13;

FIG. 24 is a diagram showing a schedule result of the instruction L13;

FIG. 25 is a diagram showing a schedule of a related art as a comparative example; and

FIG. 26 is a schematic block diagram showing the configuration of a program parallelizing apparatus according to a second exemplary example of the present invention.

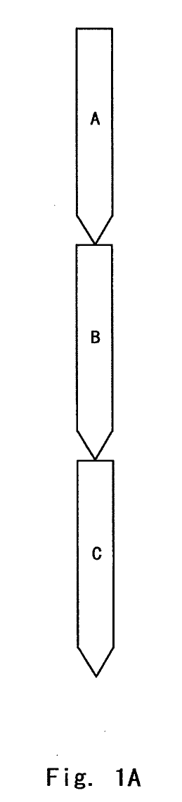

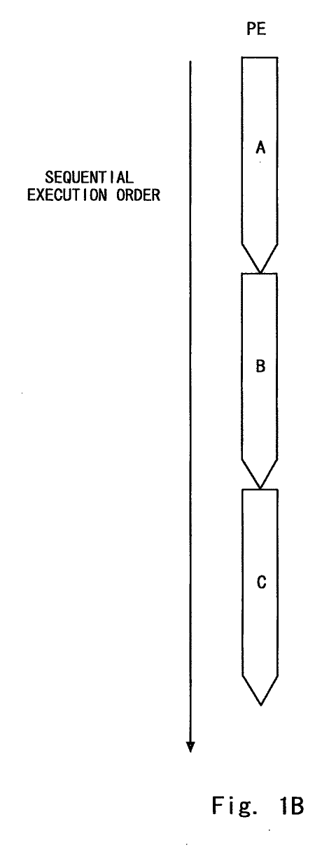

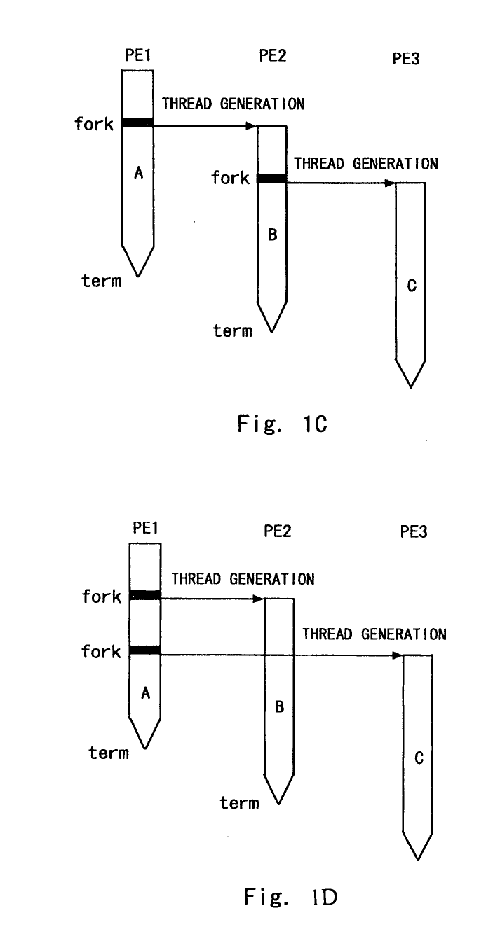

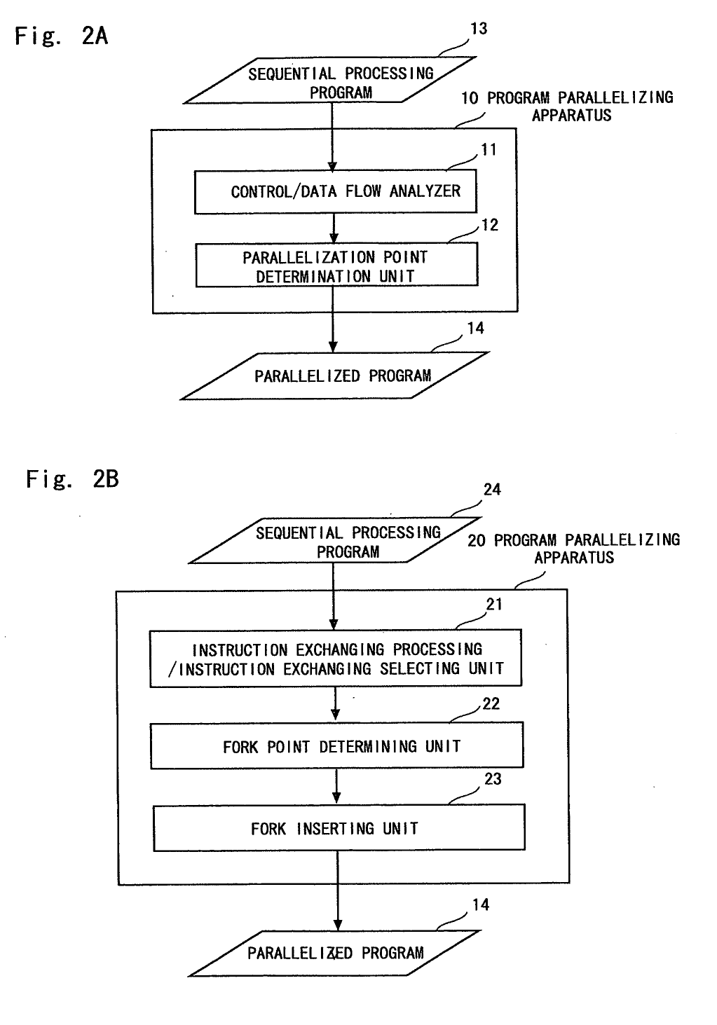

### EXPLANATION OF REFERENCE

100,100A PROGRAM PARALLELIZING APPARATUS
101,101A PROCESSING APPARATUS
102 DEPENDENCY ANALYZING/SCHEDULING UNIT
103 FUNCTION INTERNAL/EXTERNAL DEPENDENCY ANALYZING UNIT
104 INSTRUCTION SCHEDULING UNIT
301 STORAGE DEVICE
302 SEQUENTIAL PROCESSING INTERMEDIATE PROGRAM
303 STORAGE DEVICE
304 INTER-INSTRUCTION DEPENDENCY INFORMATION
305 STORAGE DEVICE
306 PARALLELIZATION INTERMEDIATE PROGRAM
401 STORAGE DEVICE
402 SEQUENTIAL PROCESSING PROGRAM
403 STORAGE DEVICE
404 PROFILE DATA
405 STORAGE DEVICE
406 PARALLELIZED PROGRAM
101.1 CONTROL FLOW ANALYZING UNIT
101.2 SCHEDULE REGION FORMING UNIT
101.3 REGISTER DATA FLOW ANALYZING UNIT
101.4 INTER-INSTRUCTION MEMORY DATA FLOW ANALYZING UNIT
101.5 REGISTER ALLOCATING UNIT
101.6 PROGRAM OUTPUTTING UNIT

### BEST MODES FOR CARRYING OUT THE INVENTION

### 1. First Exemplary Embodiment

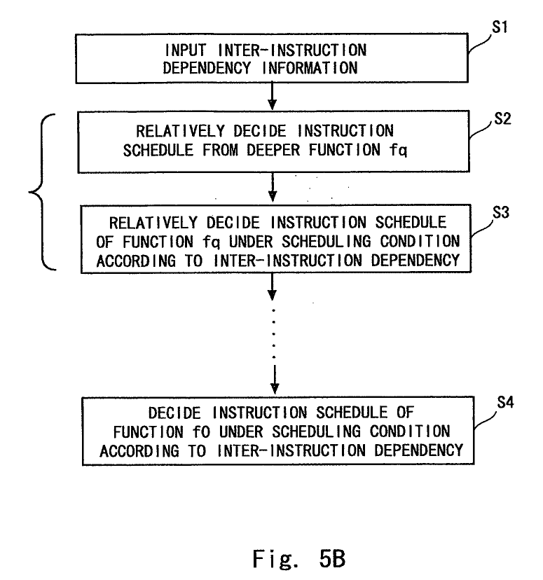

Hereinafter, a program parallelizing method according to the first exemplary embodiment of the present invention will be described with reference to FIGS. 5A to 7B.

### 1.1) Schematic Outline

According to the present invention, parallelization of a program is executed with reference to inter-instruction dependency. Especially, according to the first exemplary embodiment of the present invention, an execution cycle and an execution processor of instructions are determined based on dependency between an instruction in one function and an instruction of a function group of a descendant of the function in a function calling graph, so as to produce a parallelized program.

FIG. 5A is a schematic diagram showing one example of a function for describing the program parallelizing method according to the first exemplary embodiment of the present invention, and FIG. 5B is a flow chart showing a schematic procedure of the program parallelizing method according to the first exemplary embodiment applied to the example shown in FIG. 5A.

However, in this description, it is assumed as follows for the sake of clarity. A function f0 is a function that is not called by other functions, and two ends of a function group of its descendant are called functions fp and fq. In this example, an instruction Lp_k of the function fp is a calling instruction of the function fq. Further, as one example, it is assumed that there is dependency of data flow in which a result of an instruction L0_r of the function f0 is referred to by an instruction Lq_i of the function fq and a result of an instruction Lq_j of the function fq is referred to by an instruction Lp_1 of the function fp. In summary, a dashed arrow where the instruction Lq_j of the function fq is a source (instruction of start point) and the instruction Lp_1 of the function fp is a destination (instruction of end point) indicates inter-instruction dependency between the instruction Lq_j and the instruction Lp_l, and a dashed arrow where the instruction L0_r of the function f0 is a source and the instruction Lq_i of the function fq is a destination indicates inter-instruction dependency between the instruction L0_r and the instruction Lq_i. Note that the inter-instruction dependency is merely an example for description, and the inter-instruction dependency may be shown between any other functions. Further, the inter-instruction dependency includes not only the dependency by the data reference but also the dependency by a branch instruction or the like.

As shown in FIG. 5B, the inter-instruction dependency as shown in FIG. 5A is firstly provided as information (step S1). Then, the instruction Lp_k of the function fp calls for the function fq. As the function fq does not call for other functions, relative scheduling of an instruction of the function fq is started (step S2). This is because, in performing analysis of dependency of one function, information of a function of a descendant called by this function is required, and analysis needs to be performed from deeper functions in series.

Now, scheduling of an instruction means to decide a processor and a cycle (execution time) where the instruction is executed. In other words, it means to decide in which position of the schedule space designated by the cycle number and the processor number the instruction should be allocated. Further, “schedule space” means a space indicated by a coordinate axis of the cycle number indicating the execution time and a plurality of processor numbers. As there is a limit in the number of processors, however, it is needed to set the limit in the processor number of the schedule space, or otherwise use a residue obtained by dividing the processor number of the schedule space by an actual number of processors as the processor number for execution without limiting the processor number of the schedule space.

Further, “relative schedule” here means a schedule indicating an increasing amount from a basis, which is the processor number and the execution cycle where the function (function fq, in this embodiment) starts the execution. Although the schedule of the instruction of the function fq in step S2 is determined by referring to the existing inter-instruction dependency, only the relative positional relation in the schedule space is determined for these instructions Lq. This is because, as the function fq is called by the function calling instruction Lp_k of the function fp, the schedule of the instruction of the function fq is never determined unless the schedule of the instruction Lp_k is determined. Thus, in this example, unless the schedule of the final function f0 is determined, the schedule of the instruction of the function group of its descendant is not determined.

Then, the inter-instruction dependency between the instruction Lq_j and the instruction Lp_l is referred, and the relative schedule of the instruction of the function fp is determined so as to meet the scheduling condition to realize the shortest instruction execution time as a whole and to keep the inter-instruction dependency (step S3). At this time, the inter-instruction dependency between the instruction L0_r and the instruction Lq_i is continued in the function calling instruction Lp_k of the function fp, which is referred similarly as in step S3 in scheduling the function of the ancestor of the function fp. As such, steps S2 and S3 are recursively executed for the function f0. Finally, the schedule of the instruction of the function f0 is determined, and schedules of the instructions of all the functions are determined.

The schedules thus determined satisfy the scheduling condition to realize the shortest instruction execution time and to keep the inter-instruction dependency. If this scheduling condition is generalized, (a) the dependency between the instruction in the function f and the instruction of the function group of the descendant of the function f in the function calling graph is satisfied, and (b) the whole execution time of the instructions in the function f and in the function group of its descendant becomes the shortest.

Note that the program parallelizing method according to the first exemplary embodiment may be implemented by executing the program parallelizing program on the program control processor, or may be implemented by hardware.

Although the functions fp and fq are shown as the function groups of the descendants of the function f0 in FIGS. 5A and 5B for the sake of clarity, the scheduling process of this function calling relation may be recursively applied with respect to a function calling model of any depth.

### 1.2) Specific Example

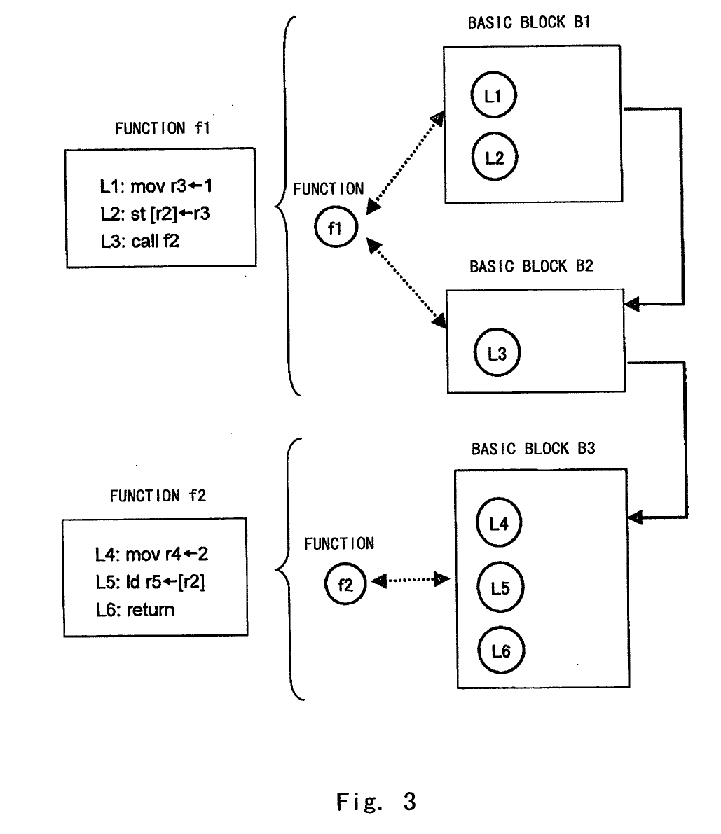

Next, a case will be described in which the first exemplary embodiment is applied to the input program of FIG. 3 described as a related art.

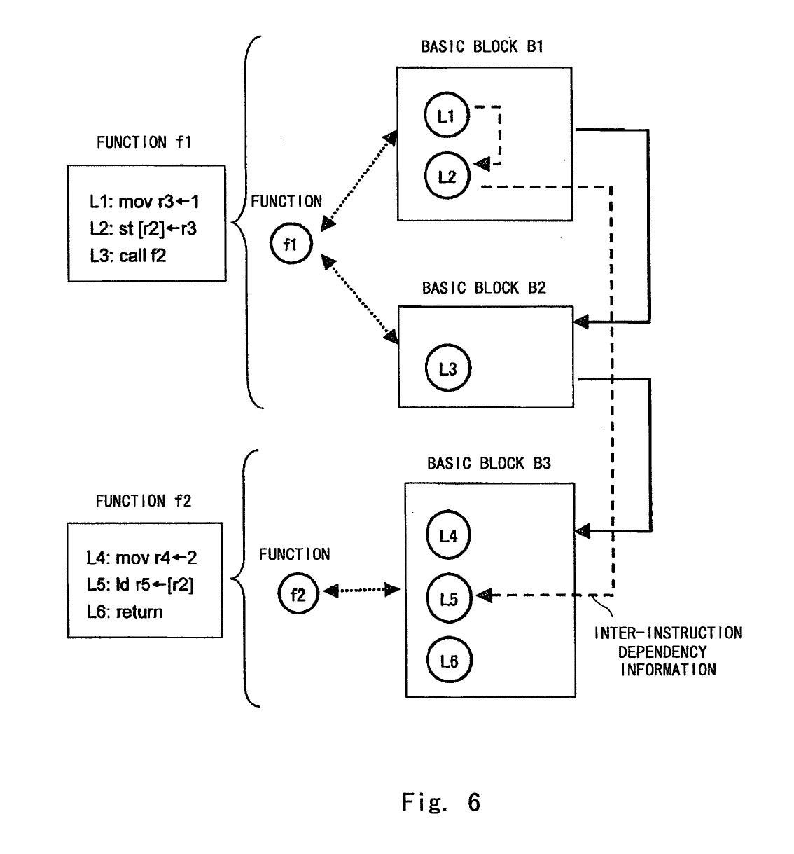

FIG. 6 is a configuration diagram of an intermediate program shown by an internal representation when the functions f1 and f2 are processed by a program parallelizing apparatus. The functions f1 and f2, and basic blocks B1 to B3 are obtained by analyzing the input program. The functions f1 and f2 are represented by nodes indicating functions, the function f1 is composed of the basic blocks B1 and B2, and the relation between the function and the basic blocks are shown by dotted arrows. The basic block B1 is composed of instructions L1 and L2, and the relation between each of the basic blocks and the instruction is shown by surrounding them by a square. The basic block B2 is assumed to be composed of an instruction L3. The function f2 is composed of the basic block B3, and the basic block B3 is composed of instructions L4, L5, and L6.

The control in such a case is such that the basic block B1 is executed, and thereafter the operation moves to the basic block B2, where the function calling instruction L3 is executed, and thereafter the operation moves to the basic block B3. This control flow is shown by solid arrows. Further, as there are inter-instruction dependency by a data flow in which the data defined by the instruction L1 is referred to by the instruction L2 and inter-instruction dependency by a data flow in which the data defined by the instruction L2 is referred to by the instruction L5, each of the inter-instruction dependencies is shown by a dashed arrow. When there is dependency by the data flow from one instruction X to one instruction Y, the instruction Y should be executed at a time where the execution delay time is added to the execution time of the instruction X or later, and the execution delay time of all the instructions is one cycle.

As described above, the relative schedule has been completed in the function f2, and as a result, the instruction L4, the instruction L5, and the instruction L6 are arranged in one processor in this order (the cycle number and the processor number have not been determined).

According to the first exemplary embodiment, the information regarding the execution processor and the execution cycle of the instruction can be analyzed for the dependency between the instruction in one function and the instruction of the function group of the descendant of its function in the function calling graph. By this analysis, it can be seen that 1) there is dependency from the instruction L2 to the instruction L5; 2) as the instruction L5 is executed through the function calling instruction L3, the relation of the execution time between the instruction L2 and the instruction L3 may satisfy the dependency from the instruction L2 to the instruction L5; 3) the function f2 starts execution one cycle later than the execution of the instruction L3, and the instruction L5 is executed on the same processor as the start point one cycle later than the start.

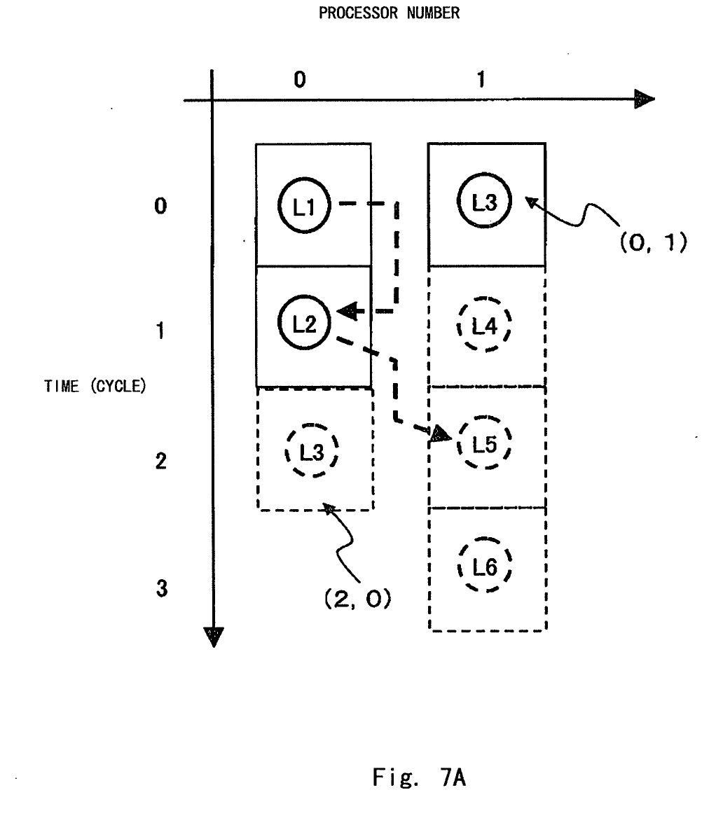

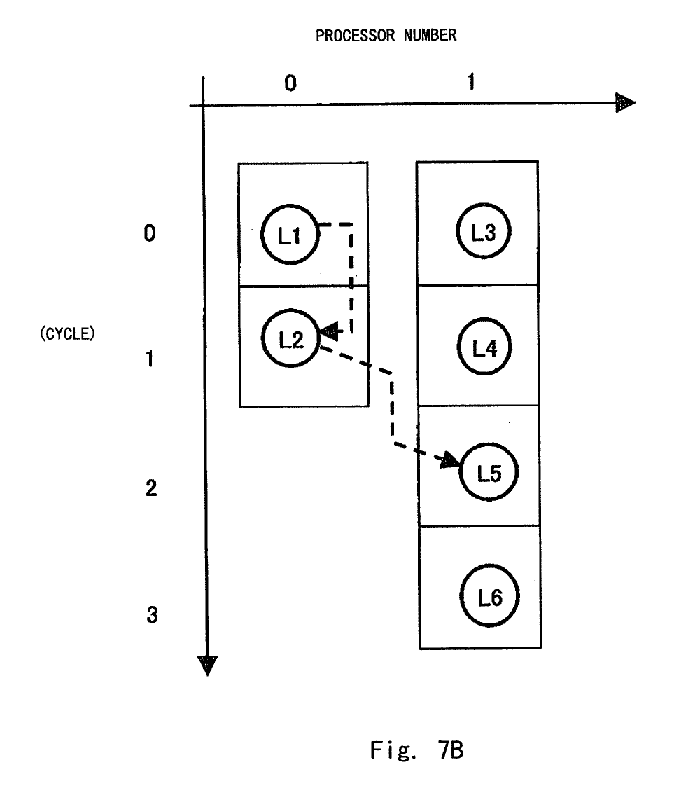

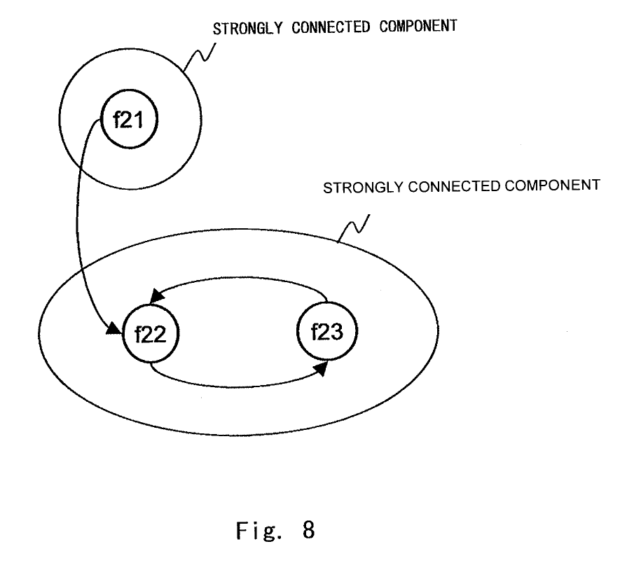

FIGS. 7A and 7B are schematic diagrams showing an allocating example of a schedule space for describing a parallelization procedure according to the first exemplary embodiment. When the instruction schedule is performed using the above analysis result, as shown in FIG. 7A, the function calling instruction L3 may be arranged in a position (2,0) or in a position (0,1) of the schedule space. This is because, as the scheduled instructions L4 to L6 of the function f2 are arranged in one cycle later than the function calling instruction L3, the function calling instruction L3 may be arranged so that the instruction L5 is arranged at a time obtained by adding the delay time one cycle of the instruction L2 to the execution time of the instruction L2 or later.

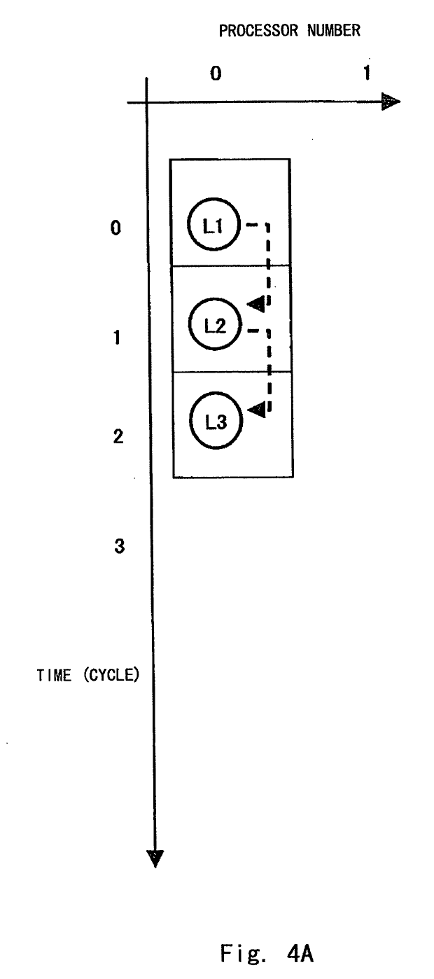

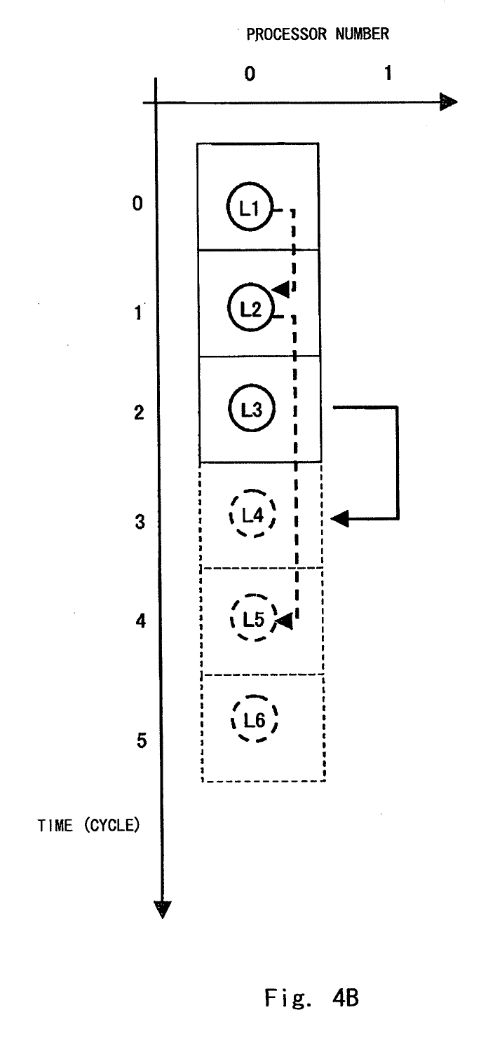

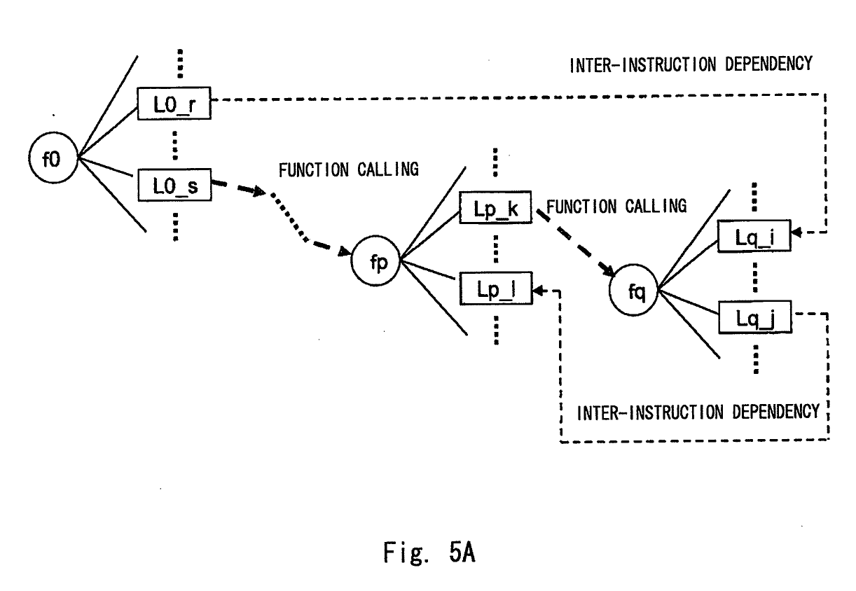

Further, the function calling instruction L3 is determined to be arranged in a position (0,1) from the condition of the shortest execution time of the above scheduling constraint condition (b). As such, according to the first exemplary embodiment, the instruction L3 can be arranged in a cycle prior to the instruction L2. In execution, the processing is performed as shown in FIG. 7B, and the processing of the functions f1 and f2 is completed in an execution time of four cycles in total. In the related art, time for six cycles is required as shown in FIG. 4B. The effective parallel processing is made possible according to the present invention.

As stated above, according to the present invention, the scheduling is executed in consideration of the dependency between the instruction in one function f and the instruction of the function group of the descendant of this function f in the function calling graph, whereby the instruction can be arranged in the appropriate time (cycle) and the processor to obtain the parallelized program with shorter parallel execution time.

### 2. Second Exemplary Embodiment

As described above, in performing analysis of the dependency of a function, information of a function called by the function is needed, and therefore, the analysis is performed from deeper functions. However, the order of the analysis cannot be determined for the function group having interdependency by the mutual recursive call. Accordingly, the function group having such an interdependency is collectively analyzed as “strongly connected component” of the function calling graph.

According to the second exemplary embodiment of the present invention, in the strongly connected component that is formed of a function group having interdependency, a method is employed for determining the instruction schedule by performing analysis of the inter-instruction dependency in each function for a predetermined number of times. The “strongly connected component” in the second exemplary embodiment will be described first.

(Strongly Connected Component)

FIG. 8 is a function calling graph for describing the strongly connected component. Each vertex f21, f22, and f23 corresponds to a function, and a directed side corresponds to calling relation. It is assumed here that the function f22 and the function f23 perform mutual recursive call. In this case, there are a path from the function f22 to the function f23 and a path from the function f23 to the function f22. The strongly connected component collects up such functions f22 and f23. The function group having such an interdependency can be collected as the strongly connected component.

An algorithm for obtaining the strongly connected component has already been known. For example, vertices of the graph (corresponding to functions in this example) are firstly numbered with a post-order, and thereafter, a graph which is obtained by reversing all the directed sides of the graph is created. Then, a depth-first search is started at a vertex whose number is maximum on the reversed graph, so as to create a tree by traversed ones. Then, the depth-first search is started at a vertex whose number is maximum for vertices that have not been searched, so as create a tree by traversed ones. This process is repeated. Each tree that is produced is the strongly connected component. Other algorithms include a method disclosed in pp. 195 to 198 of “Data Structure and Algorithm” (A. V. Eiho et al., translated by Yoshio Ohno, Baifukan Co., LTD, 1987). Next, specific examples of the function calling graph and the strongly connected component will be described.

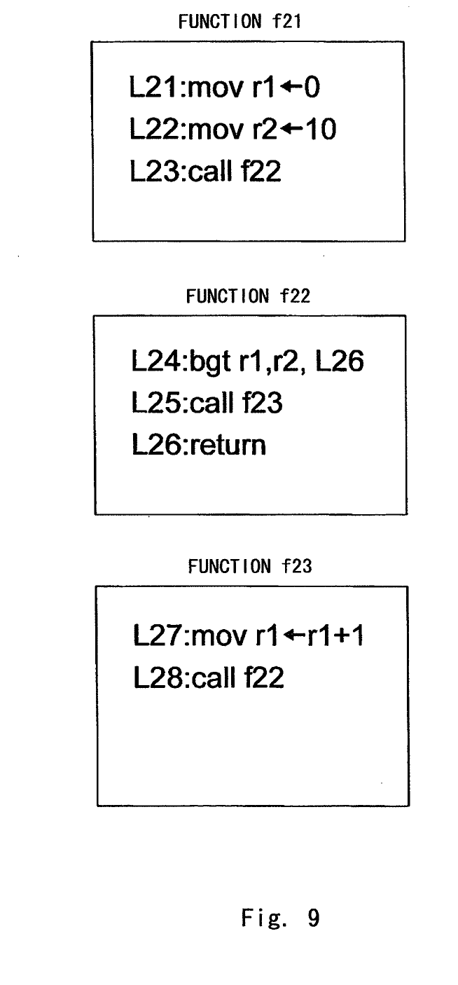

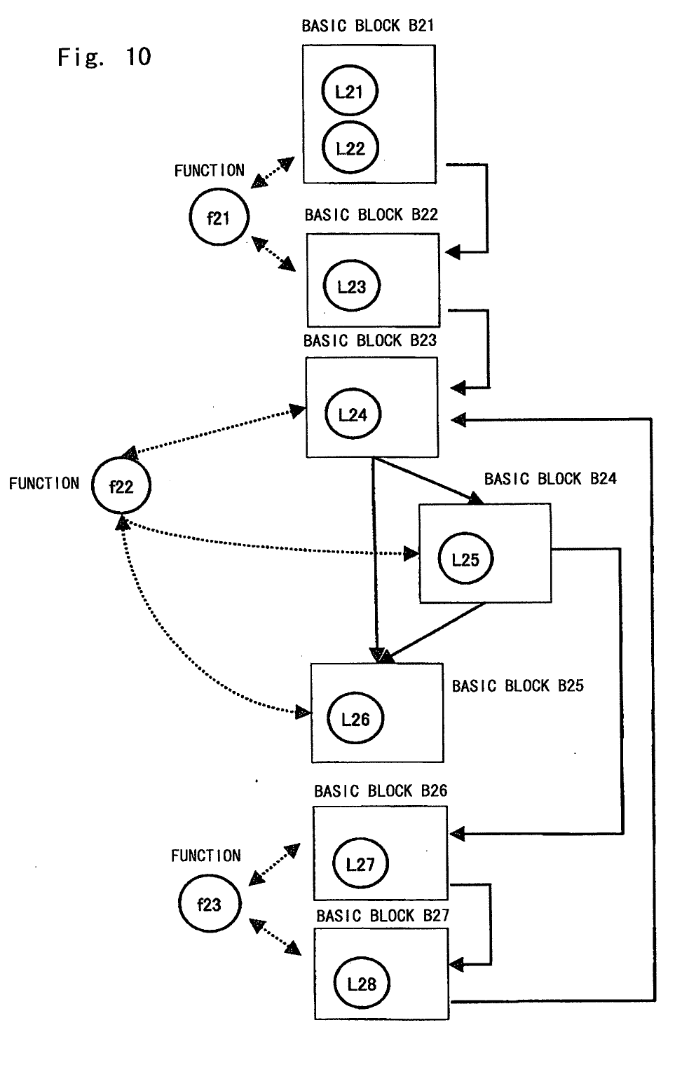

FIG. 9 is a diagram showing one example of the input program for describing the strongly connected component. The input program is composed of functions f21, f22, and f23, and execution is started from the function f21. In this example, the function f21 calls for the function f22 by a function calling instruction L23, the function f22 calls for the function f23 by a function calling instruction L25, and the function f23 calls for the function f22 by a function calling instruction L28.

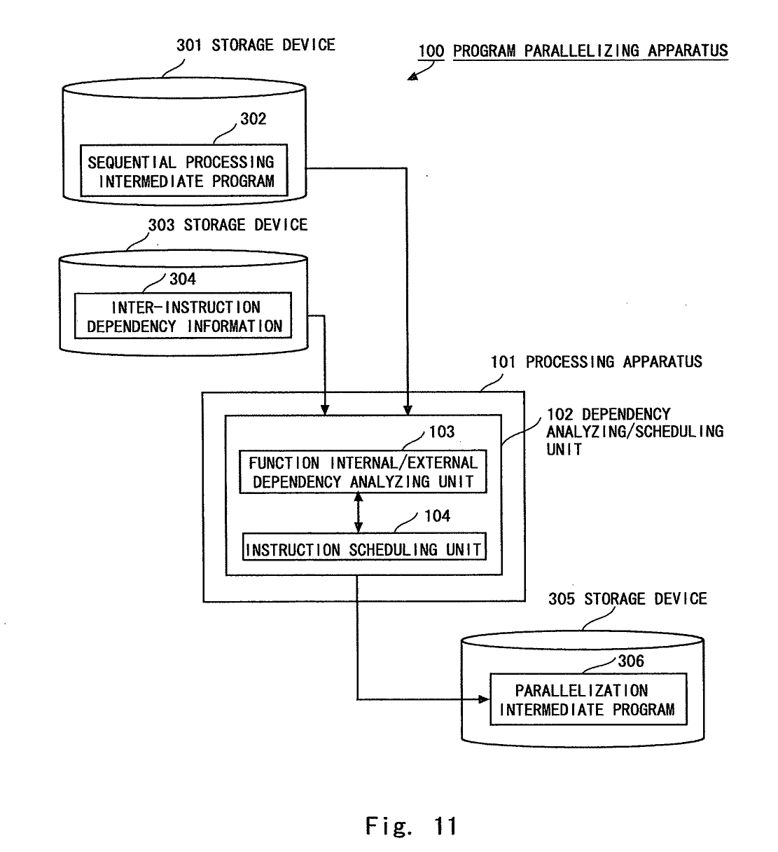

FIG. 10 is a diagram showing the sequential processing intermediate program corresponding to the input program of FIG. 9. The functions f21, f22, and f23 are represented by the nodes indicating the functions. The function f21 is formed of the basic blocks B21 and B22, and the relation is shown by dotted arrows. The basic block B21 is formed of the instructions L21 and L22, and the basic block B22 is formed of the instruction L23. The relation between the basic block and the instruction is shown by surrounding them by a square. The functions f22 and f23 are similar as well.

The control is moved to the basic block B22 after executing the basic block B21, and moved to the basic block B23 after executing the function calling instruction in the basic block B22. Further, the instruction L24 of the basic block B23 is a conditional branch instruction, and the control is moved to a basic block B25 or a basic block B26 in accordance with the condition. Further, the control is moved to the basic block B26 after executing the function calling instruction in the basic block B24, and is moved to a basic block B27 after executing the basic block B26. Further, the control is moved to the basic block B23 after executing the function calling instruction in the basic block B27, and is moved to the basic block B25 after executing the basic block B24. Each control flow will be shown by a solid arrow.

Such a function calling relation is shown in FIG. 8. It is assumed, however, that the strongly connected component also treats a single function as the strongly connected component, not only the interdependency of a plurality of functions in the following description. In summary, as shown in FIG. 8, the function f21 forms one strongly connected component of the function calling graph by itself, and the functions f22 and f23 form another strongly connected component. As such, in the second exemplary embodiment of the present invention, the program parallelization is executed by a unit of the strongly connected component. An exemplary example of the present invention will now be described in detail.

### Example 1

### 3. First Exemplary Example

### 3.1) Apparatus Configuration

FIG. 11 is a schematic block diagram showing the configuration of a program parallelizing apparatus according to the first exemplary example of the present invention. A program parallelizing apparatus 100 according to the first exemplary example realizes a dependency analyzing/scheduling unit 102 in the processing apparatus 101 by software or hardware. The dependency analyzing/scheduling unit 102 includes a function internal/external dependency analyzing unit 103 and an instruction scheduling unit 104 as will be described later, receives a sequential processing intermediate program 302 stored in a storage device 301 and an inter-instruction dependency information 304 stored in a storage device 303, and generates a parallelization intermediate program 306 to store it in a storage device 305.

The sequential processing intermediate program 302 is created by a program analyzing apparatus which is not shown, and is represented as a graph. For example, the sequential processing intermediate program 302 is a program in which the functions, the basic blocks, and the dependencies thereof shown in FIG. 3 are described, and the functions and the instructions that form the sequential processing intermediate program 302 are represented as nodes indicating them. Further, the loop may be converted to a recursive function and represented as the recursive function. Further, in the sequential processing intermediate program 302, as shown in FIG. 3, the schedule region which is the target of the instruction scheduling is determined. The schedule region may be one basic block or may be a plurality of basic blocks, for example.

The inter-instruction dependency information 304 is information of inter-instruction dependency and information related to it. The inter-instruction dependency information 304 is, for example, information regarding inter-instruction dependency shown by dotted arrows in FIG. 6. The inter-instruction dependency information 304 is inter-instruction dependency obtained by the analysis of the data flow in accordance with the reading or writing of the register and the memory and the analysis of the control flow, and is shown by a directed side that connects nodes showing instructions (FIG. 5A). Although the detail will be described later with reference to FIG. 22, the relative value of the execution time regarding the source (instruction of start point), the relative value of the execution processor number, and the delay time of the source instruction are added to the directed side. The initial values of the relative value of the execution processor number and the relative value of the execution time are both set to zero. Further, the relative value of the execution time regarding the destination (instruction of end point) and the relative value of the execution processor number are added to the directed side. The initial values are set to zero.

The dependency analyzing/scheduling unit 102 includes a function internal/external dependency analyzing unit 103 and an instruction scheduling unit 104. The function internal/external dependency analyzing unit 103 analyzes the inter-instruction dependency by referring to the dependency information 304 between the instructions. In short, the dependency between an instruction in one function f and an instruction of the function group of the descendant of the function f in the function calling graph is analyzed. According to the analyzed dependency, the instruction scheduling unit 104 determines the execution time and the execution processor of the instructions, and the execution order of the instructions is determined so as to realize the execution time and the execution processor of the instructions that are determined to insert the fork command. The parallelization intermediate program 306 is thus registered in the storage device 305.

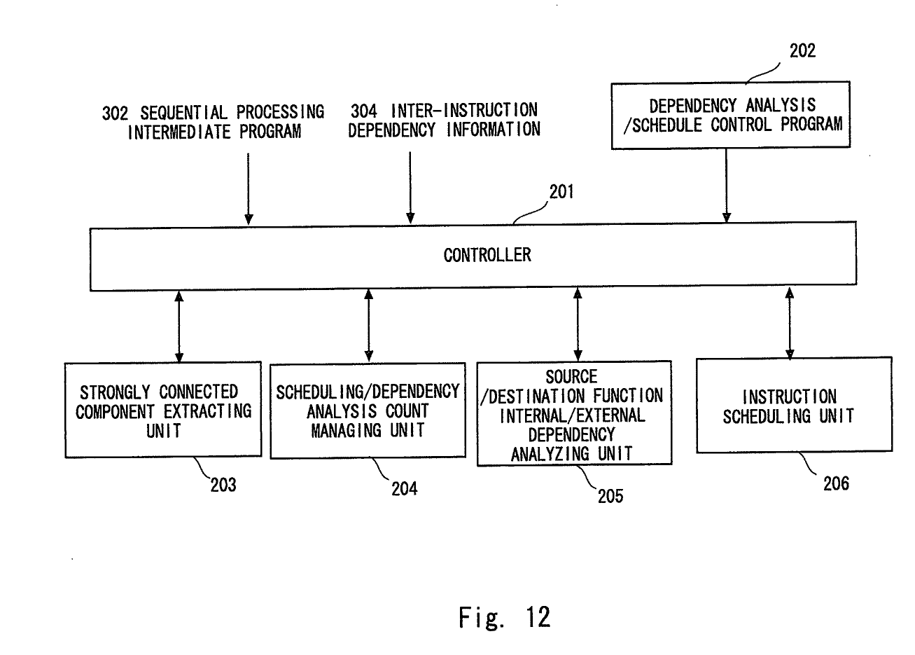

Note that the processing apparatus 101 is the information processing apparatus such as a central processing unit CPU, and the storage devices 301, 303, and 305 are storage devices such as a magnetic disk unit. The program parallelizing apparatus 100 may be realized by a program and a computer such as a personal computer and a work station. The program is recorded in a computer-readable recording medium such as a magnetic disk, read out by a computer when it is activated, controls the operation of the computer, so as to realize function means such as the dependency analyzing/scheduling unit 102 on the computer. For example, the processing apparatus may be configured as shown in FIG. 12.

FIG. 12 is a block diagram showing one example of the processing apparatus according to the first exemplary example. In this example, a controller 201 formed of a program control processor reads out a dependency analysis/schedule control program 202 from the memory for execution. The controller 201 controls a strongly connected component extracting unit 203, a scheduling/dependency analysis count managing unit 204, a source/destination function internal/external dependency analyzing unit 205, and an instruction scheduling unit 206, and executes the program parallelization operation described next.

The strongly connected component extracting unit 203 extracts the strongly connected component from the input sequential processing intermediate program 302, and assigns a number to each of the functions from the deeper functions in a way that smaller numbers are assigned to the deeper functions. For example, in the function calling graph shown in FIG. 8, the numbers of a post-order are assigned as follows. The functions f21, f22, and f23 are followed along with the directed side, and as there is no function that is not followed any longer, the post-order of the function f23 is “1”. Then it moves back to the function f22, and as there is no function that is not followed any longer, the post-order of the function f22 is “2”. Lastly, it moves back to the function f11, and as there is no function that is not followed any longer, the post-order of the function f11 is “3”. As such, smaller numbers may be assigned to the deeper functions. The method for obtaining the post-order includes the one disclosed in pp. 195 to 198 of “Data Structure and Algorithm” (A. V. Eiho et al., translated by Yoshio Ohno, Baifukan Co., LTD, 1987).

Although described later in detail, the scheduling/dependency analysis count managing unit 204 manages the number of times of execution of the dependency analysis and the scheduling of the strongly connected component in accordance with the dependency form of the function that forms the strongly connected component.

The source/destination function internal/external dependency analyzing unit 205 refers to the inter-instruction dependency information 304, as described above, and analyzes the dependency between the instruction in one function f and the instruction of the function group of the descendant of the function f in the function calling graph. According to the dependency that is analyzed, the instruction scheduling unit 206 determines the execution time and the execution processor of the instructions, and determines the execution order of the instructions to realize the execution time and the execution processor of the instructions that are determined, to insert the fork command.

Note that the device that generates the inter-instruction dependency information 304 may be provided. In the following, the inter-instruction dependency information generating circuit will be described in brief.

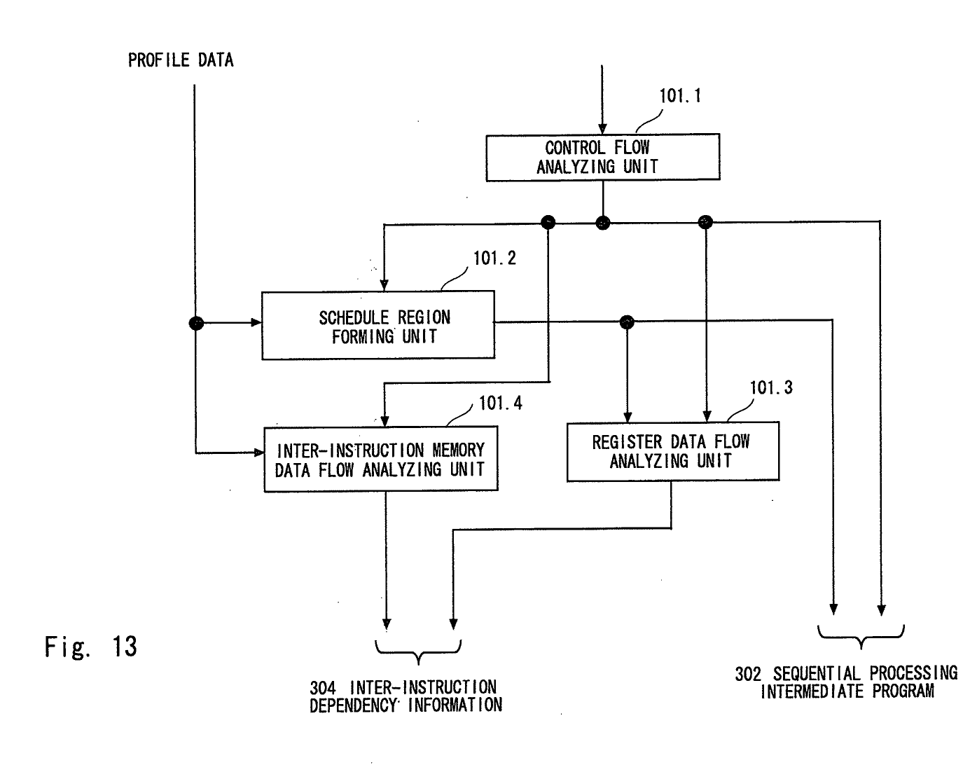

FIG. 13 is a block diagram showing one example of the circuit that generates the inter-instruction dependency information. A control flow analyzing unit 101.1 analyzes the control flow of the sequential processing program, and outputs the analysis result to a schedule region forming unit 101.2, a register data flow analyzing unit 101.3, and an inter-instruction memory data flow analyzing unit 101.4.

The schedule region forming unit 101.2 refers to the control flow analysis result and the profile data of the sequential processing program, so as to determine the schedule region which will be a unit of the instruction schedule.

The register data flow analyzing unit 101.3 refers to the control flow analysis result and the schedule region determined by the schedule region forming unit 101.2 to analyze the data flow in accordance with the reading or writing of the register.

The inter-instruction memory data flow analyzing unit 101.4 refers to the control flow analysis result and the profile data of the sequential processing program to analyze the data flow in accordance with the reading or writing of a memory address.

The analysis result of the data flow in accordance with the reading or writing of the register and the memory obtained by the register data flow analyzing unit 101.3 and the inter-instruction memory data flow analyzing unit 101.4 is output to the dependency analyzing/scheduling unit 102 as the inter-instruction dependency information 304, and the control flow analysis result and the schedule region are output as the sequential processing intermediate program 302 to the dependency analyzing/scheduling unit 102.

### 3.2) Program Parallelization Operation

FIG. 14 is a flow chart showing the whole operation of the dependency analysis and the schedule processing processed by the dependency analyzing/instruction scheduling unit 108.

First, the strongly connected component extracting unit 203 refers to the sequential processing intermediate program 302 to obtain the strongly connected component of the function calling graph. Next, the strongly connected component of the function calling graph is processed in a specific order. For example, in order to prevent the function that has already been processed from being processed again, all the strongly connected components are firstly marked as unselected, and then the processed one is marked as selected. As such, in a specific order, the unselected one among the strongly connected components of the function calling graph is set to a strongly connected component s (step S101). The order for selecting the strongly connected components is determined in a way that one function that forms the strongly connected component is selected and the one having smaller index value of the post-order of the function is preceded.

Next, the unselected one among the functions that form the strongly connected component s is set to a function f in a specific order (step S102). The function having smaller index value applied in the pre-order of the function calling graph may be preceded, for example, as the order of the functions that form the strongly connected component s.

Then, the instruction scheduling unit 206 performs the instruction schedule for each function. More specifically, the execution time and the execution processor of the instruction are determined for each schedule region in the function, and the execution order of the instructions is determined so as to realize the execution time and the execution processor of the instruction that are determined. Then, the fork command is inserted to be stored in a memory which is not shown (step S103).

Next, the controller 201 judges whether all the functions of the strongly connected component s are scheduled (step S104), and when there is a function that is not scheduled (No in step S104), the control is made back to step 102.

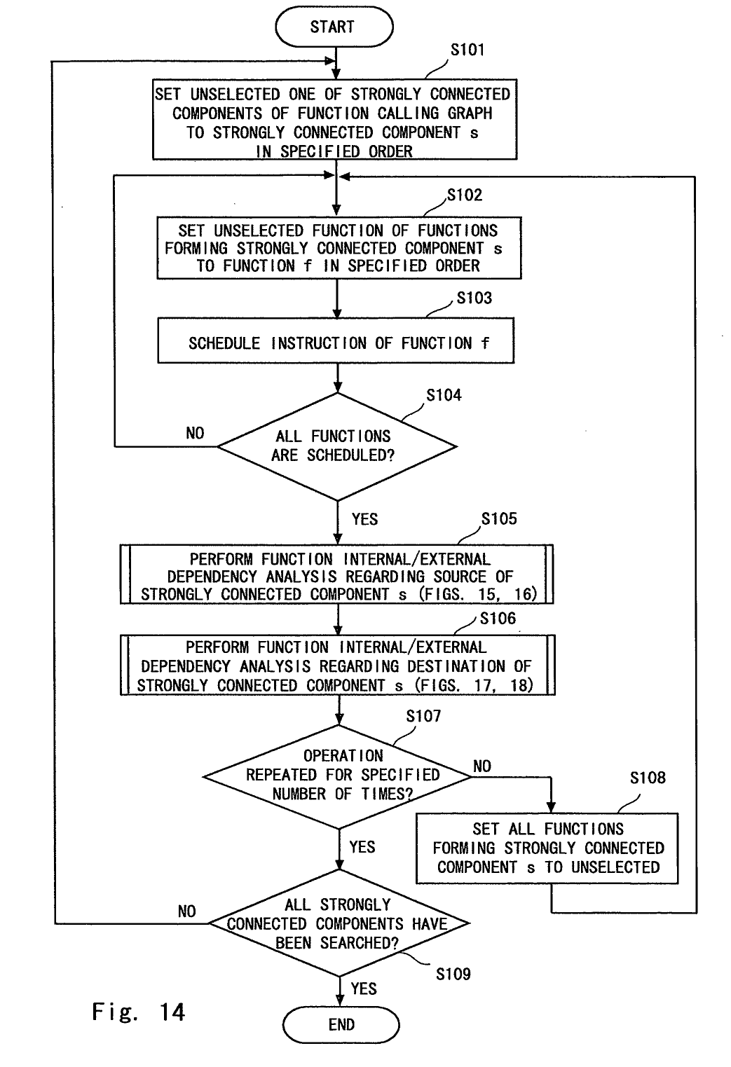

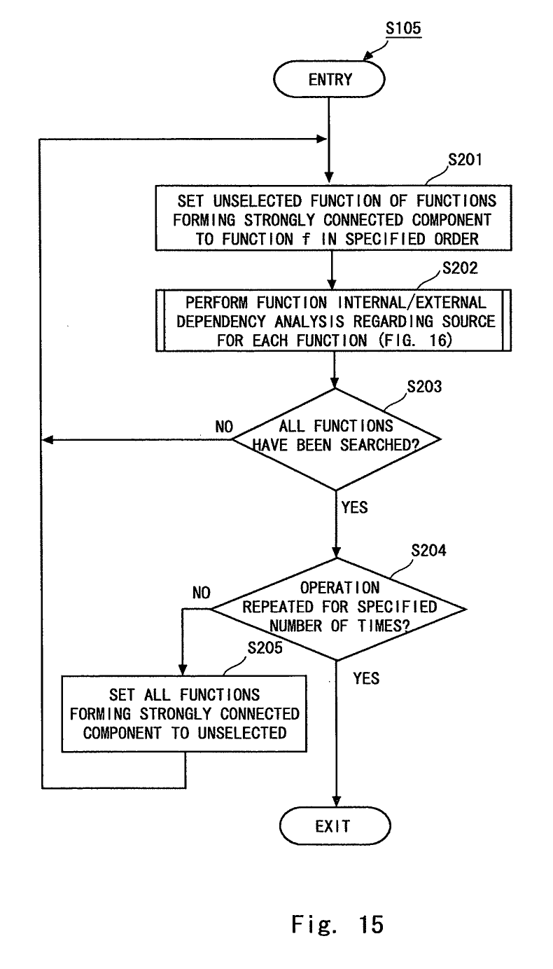

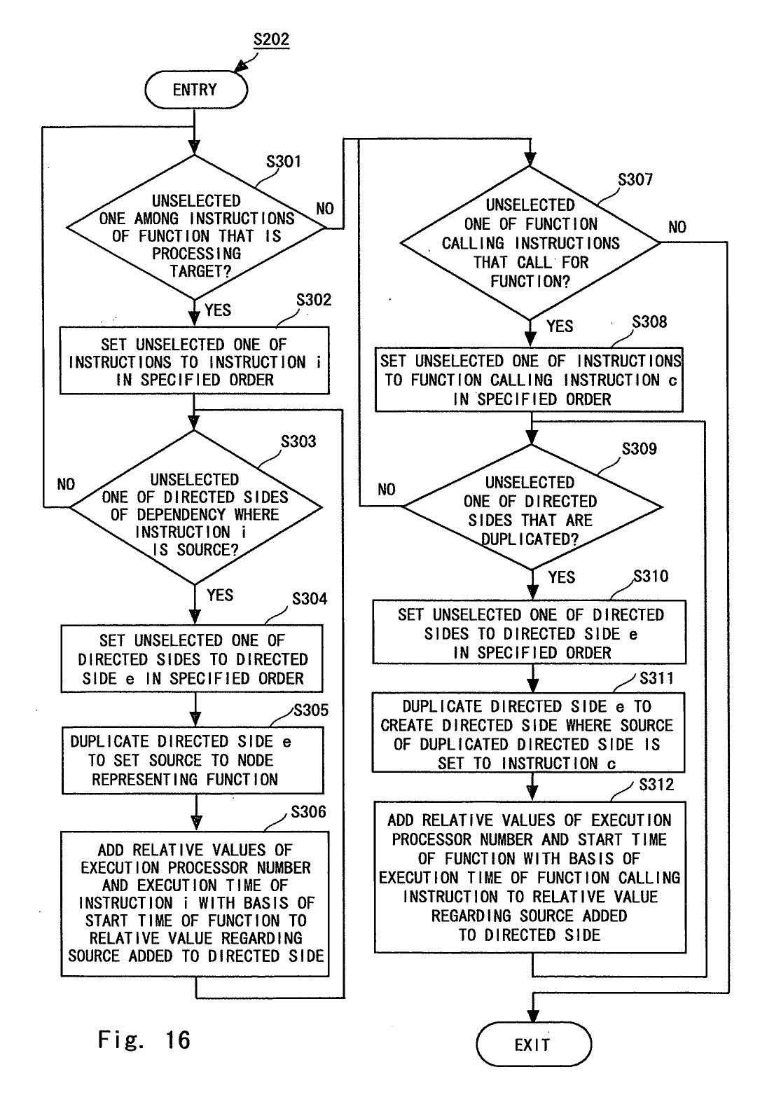

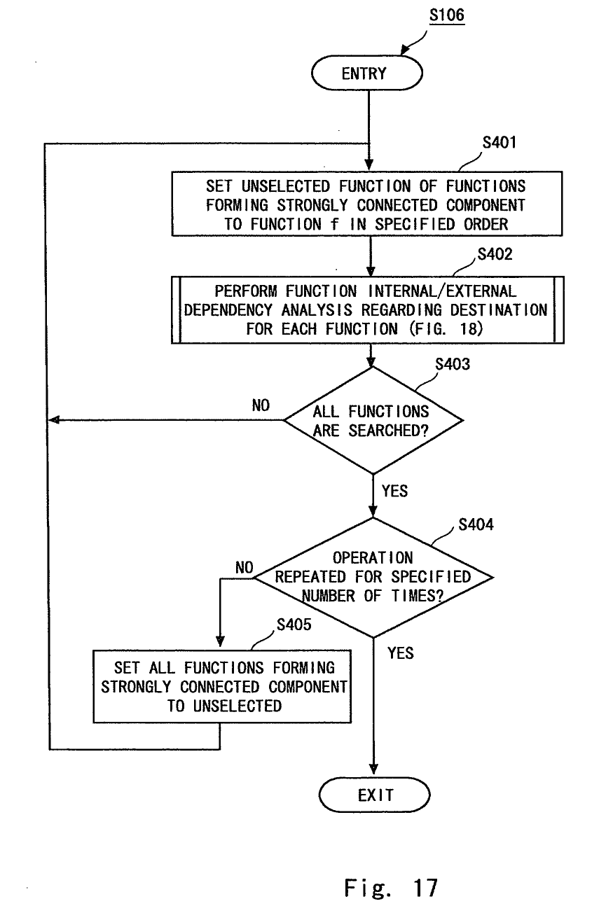

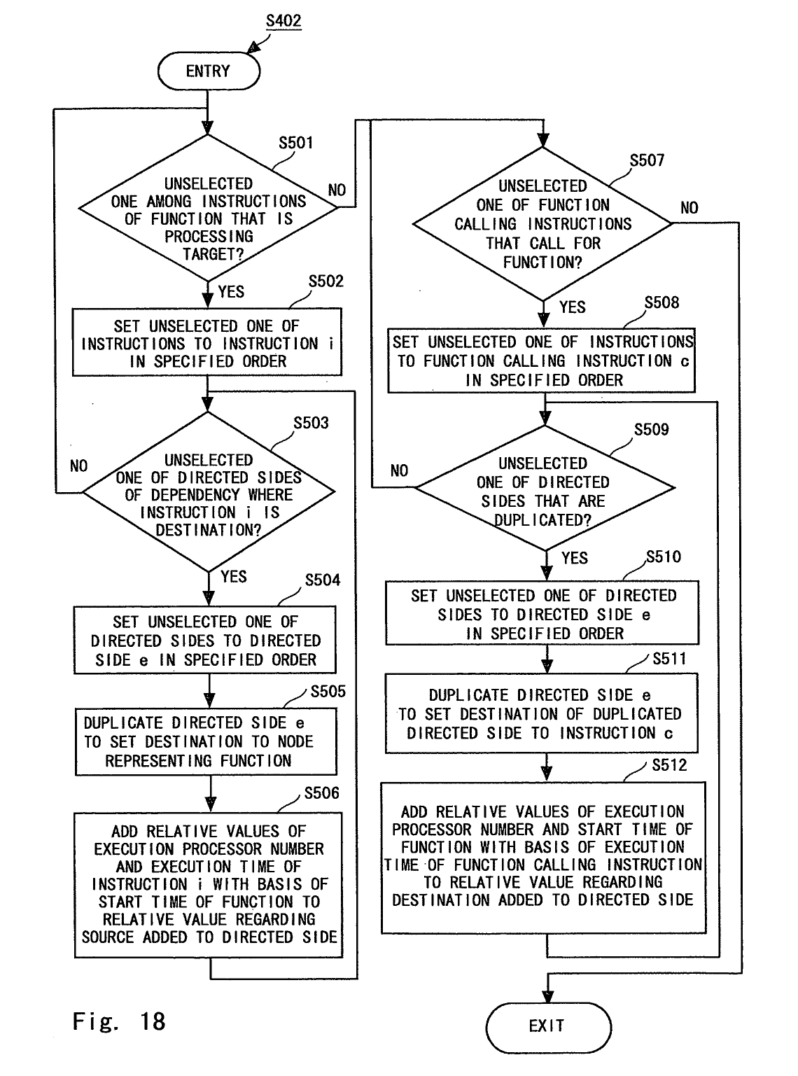

If the schedules of all the functions included in the selected strongly connected component s are completed (Yes in step S104), the controller 201 instructs the source/destination function internal/external dependency analyzing unit 205 to execute the function internal/external dependency analysis regarding the source (step S105) and the function internal/external dependency analysis regarding the destination (step S106) of the directed side that shows the dependency of the strongly connected component s. The function internal/external dependency analysis regarding the source will be described in detail with reference to FIGS. 15 and 16, and the function internal/external dependency analysis regarding the destination will be described in detail with reference to FIGS. 17 and 18.

Then, the scheduling/dependency analysis count managing unit 204 judges whether the repeat count of the loop from step S102 to step S106 has reached a specified value of the strongly connected component s (step S107). If the repeat count has not reached the specified value (No in step S107), the scheduling/dependency analysis count managing unit 204 sets all the functions that form the strongly connected component s to unselected (step S108), and the control is made back to step S102. The analysis from step S102 to step S106 is repeatedly performed because, when there is interdependency by recursive call or mutual recursive call in the functions that form the strongly connected component s, the results of the dependency analysis and the schedule in one function need to be employed in the dependency analysis and the schedule in other functions. The repeat count can be set to once or a plurality of times according to the form of the strongly connected component s in the function calling graph. For example, when there is a directed side between the functions that form the strongly connected component s in the function calling graph, the repeat count may be set to a plurality of times (four times, for example). Further, the repeat count may be set to a plurality of times (four times, for example) also when only one function forms the strongly connected component s and this function performs the self recursive call. The repeat count may be set to once in other cases. Alternatively, the repeat count may be set to four times when the strongly connected component s represents a loop, for example, and may be set to once in other cases. As such, by repeating the analysis and the schedule, it is possible to respond to the change of the position of the dependency destination instruction by the schedule, and to obtain better schedule with respect to the strongly connected component representing a loop.

When the repeat count reaches the specified value (Yes in step S107), it is judged whether all the strongly connected components are searched (step S109). If there is a strongly connected component that is not searched (No in step S109), the control is made back to step S101. When all the strongly connected components are searched (Yes in step S109), the dependency analysis and the schedule processing are terminated.

### 3.3) Function Internal/External Dependency Analysis Regarding Source

Next, the function internal/external dependency analyzing processing regarding the source executed by the source/destination function internal/external dependency analyzing unit 205 (step S105) will be described in detail.

FIG. 15 is a flow chart showing the whole function internal/external dependency analyzing processing regarding the source, and FIG. 16 is a flow chart showing the detail of the function internal/external dependency analyzing processing regarding the source.

In FIG. 15, in a specified order, the unselected function among the functions that form the strongly connected component is set to the function f (step S201). The function having larger index value applied in the pre-order of the function calling graph may be preceded, for example, as the order of the functions that form the strongly connected component s, as already stated above.

Next, the source/destination function internal/external dependency analyzing unit 205 performs function internal/external dependency analysis regarding the source for each function (step S202). The detail will be described with reference to FIG. 16.

The controller 201 judges whether all the functions that form the strongly connected component which is the processing target are searched (step S203), and when there is a function that is not searched (No in step S203), the control is made back to S201. When all the functions are searched (Yes in step S203), it is judged whether the repeat count of the processing loop from step S201 to step S203 has reached a specified value (step S204). If the repeat count has not reached the specified value (No in step S204), all the functions that form the strongly connected component s is made unselected (step S205), and the control is made back to step S201.

The analyzing processing from step S201 to step S203 is repeatedly performed because there is interdependency by the recursive call or the mutual recursive call between the functions that form the strongly connected component s, as described above. The repeat count may be set to once or a plurality of times in accordance with the form of the strongly connected component s in the function calling graph. For example, when there is a directed side between the functions that form the strongly connected component s in the function calling graph, the repeat count may be set to a plurality of times (four times, for example). Further, the repeat count may be set to a plurality of times (four times, for example) also when there is one function that forms the strongly connected component s and this function performs the self recursive call. The repeat count may be set to once in other cases. Alternatively, when the strongly connected component represents a loop and the repeat count of this loop is known, the repeat count may be set to the repeat count of this loop.

When the repeat count has reached the specified value (Yes in step S204), the function internal/external dependency analyzing processing regarding the source for each strongly connected component is completed.

Next, with reference to FIG. 16, the function internal/external dependency analyzing processing regarding the source for each function in the above step S202 will be described in detail.

First, it is judged whether there is unselected one among the instructions of the function that is the processing target (step S301), and when there is no unselected one (No in step S301), the control is moved to step S307 stated below. When there is unselected one (Yes in step S301), in a specified order, the unselected one among the instructions of the function that is the processing target is set to an instruction i (step S302). The order of the address of the instruction may be used, for example, as the order of the selection of the instruction.

Then, it is judged whether there is unselected one among the directed sides of the dependency where the instruction i is the source (step S303), and when there is no unselected one (No in step S303), the control is moved to step S301. For example, when the function fq is the strongly connected component s in FIG. 5A, the instruction Lq_j inside the function fq is the source of the dependency to the instruction Lp_1 of the function fp.

When there is unselected one (Yes in step S303), in a specified order, the unselected one among the directed sides of the dependency where the instruction i is the source is set to a directed side e (step S304). Any order may be employed as the order of the selection of the directed side.

Next, the directed side e is duplicated, and the source of the directed side which is duplicated is replaced with the node representing the function of the processing target (step S305). Then, the relative values of the execution processor number and the execution time of the instruction i with a basis of the start time of the function of the processing target are added to the relative values of the execution processor number and the execution time regarding the source added to the directed side (step S306). Further specific operation of the processing of step S306 will be made clear in the description with reference to FIGS. 18 and 22 regarding the function internal/external dependency analysis regarding the destination.

Note that the directed side of the dependency regarding the data flow where the source is the node representing the function may be represented as a table for each function, as the number of registers is known in advance. This table includes a register number as an index, and the delay time of the instruction of the source and the relative values of the execution processor number and the execution time regarding the source added to the directed side as a content. By representing it by a table, the memory capacity that is used can be made smaller compared with a case in which a list representation is employed.

Next, it is judged whether there is unselected one among the function calling instructions that call for functions of the processing target (step S307), and when there is no unselected one (No in step S307), the function internal/external dependency analyzing processing regarding the source for each function is completed. When there is unselected one (Yes in step S307), in a specified order, the unselected one among the function calling instructions that call for functions of the processing target is set to the function calling instruction c (step S308).

Next, it is judged whether there is unselected one among the directed sides that are duplicated (step S309), and when there is no unselected one (No in step S309), the control is moved back to step S307. When there is unselected one (Yes in step S309), in a specified order, the unselected one among the directed sides is set to the directed side e (step S310).

Next, the directed side e is duplicated to create a directed side where the source of the directed side that is duplicated is set to the instruction c (step S311), and the relative values of the execution processor number and the start time of the function of the processing target with a basis of the execution time of the instruction c are added to the relative values of the execution processor number and the execution time regarding the source added to the directed side (step S312). The specific operation of the processing of step S312 will be made clear in the description with reference to FIGS. 18 and 22 regarding the function internal/external dependency analysis regarding the destination.

Then, the control is made back to step S309, and steps S310 to S312 are repeated until when there is no unselected one among the directed sides that are duplicated.

### 3.4) Function Internal/External Dependency Analysis Regarding Destination

Next, the function internal/external dependency analyzing processing regarding the destination executed by the source/destination function internal/external dependency analyzing unit 205 (step S106) will be described in detail.

FIG. 17 is a flow chart showing the whole function internal/external dependency analyzing processing regarding the destination, and FIG. 18 is a flow chart showing the detail of the function internal/external dependency analyzing processing regarding the destination.

In FIG. 17, in a specified order, the unselected function among the functions that form the strongly connected component s is firstly set to the function f (step S401). Note that the order of the functions that form the strongly connected component s may be such that the index applied in the pre-order of the function calling graph is searched, and thereafter the function having larger index value may be preceded, for example.

In the following, the function internal/external dependency analysis regarding the destination for each function is performed (step 402). The detail thereof will be described in FIG. 18.

The controller 201 judges whether all the functions that form the strongly connected component which is the processing target are searched (step S403). When there is a function which is not searched (No in step S403), the control is made back to step S401. When all the functions that form the strongly connected component which is the processing target are searched (Yes in step S403), it is judged whether the repeat count of the loop processing from step S401 to step S404 has reached a specified value (step S404). When the repeat count has not reached the specified value (No in step S404), all the functions that form the strongly connected component s are marked as unselected (step S405), and the control is made back to step S401. The repeat count may be set to once or a plurality of times according to the form of the strongly connected component s in the function calling graph. For example, in the function calling graph, when there is a directed side between the functions that form the strongly connected component s, the repeat count may be set to a plurality of times (four times, for example). Furthermore, the repeat count may be set to a plurality of times (four times, for example) also when there is one function that forms the strongly connected component s and this function performs the self recursive call. The repeat count may be set to once in other cases. Alternatively, when the strongly connected component represents a loop and the repeat count of this loop is known, the repeat count may be set to the repeat count of this loop.

When the repeat count of the loop has reached the specified value (Yes in step S404), the function internal/external dependency analyzing processing regarding the destination for each strongly connected component is completed.

Referring now to FIG. 18, the function internal/external dependency analyzing processing regarding the destination for each function in the above step S402 will be described in detail.

First, it is judged whether there is unselected one among the instructions of the function of the processing target (step S501), and if there is no unselected one (No in step S501), the control is moved to step S507. If there is unselected one (Yes in step S501), in a specified order, the unselected one among the instructions of the function of the processing target is set to an instruction i (step S502). The order of the address of the instruction may be used, for example, as the order of the selection of the instruction.

Then, it is judged whether there is unselected one among the directed sides of the dependency where the instruction i is the destination (step S503), and when there is no unselected one (No in step S503), the control is made back to step S501. When there is unselected one (Yes in step S503), in a specified order, the unselected one among the directed sides of the dependency where the instruction i is the destination is set to a directed side e (step S504). Any order may be employed as the order of the selection of the directed side.

Next, the directed side e is duplicated, and the destination of the directed side which is duplicated is replaced with the node representing the function of the processing target (step S505). The relative values of the execution processor number and the execution time of the instruction i with a basis of the start time of the function of the processing target are added to the relative values of the execution processor number and the execution time regarding the destination added to the directed side (step S506). This step S506 corresponds to operation op1 in FIG. 22, as will be described later. The step S306 shown in FIG. 16 as above is the similar operation regarding a source.

Note that, as the number of registers is known in advance, the directed side of the dependency regarding the data flow where the destination is the node representing the function may be represented as a table for each function. This table includes a register number as an index, and the relative values of the execution processor number and the execution time regarding the destination added to the directed side as a content. By representing it by a table, the memory capacity that is used can be made smaller compared with a case in which the list representation is employed.

Next, it is judged whether there is unselected one in the function calling instructions that call for functions of the processing target (step S507). When there is no unselected one (No in step S507), the function internal/external dependency analyzing processing regarding the source for each function is terminated. When there is unselected one (Yes in step S507), in a specified order, the unselected one among the function calling instructions that call for functions of the processing target is set to the function calling instruction c (step S508).

Next, it is judged whether there is unselected one among the directed sides that are duplicated (step S509), and when there is no unselected one (No in step S509), the control is moved to step S507. When there is unselected one (Yes in step S509), in a specified order, the unselected one among the directed sides is set to the directed side e (step S510).

Then, the directed side e is duplicated to create a directed side where the destination of the directed side which is duplicated is set to the instruction c (step S511), and the relative values of the execution processor number and the start time of the function of the processing target with a basis of the execution time of the instruction c are added to the relative values of the execution processor number and the execution time regarding the destination added to the directed side (step S512). This step S512 corresponds to the operation op2 in FIG. 22, as described later. The step S312 in FIG. 16 described above is the similar operation regarding the source.

Then, the control is made back to step S509, and steps S510 to S512 are repeated until when there is no unselected one among the directed sides that are duplicated.

### 3.5) Specific Example

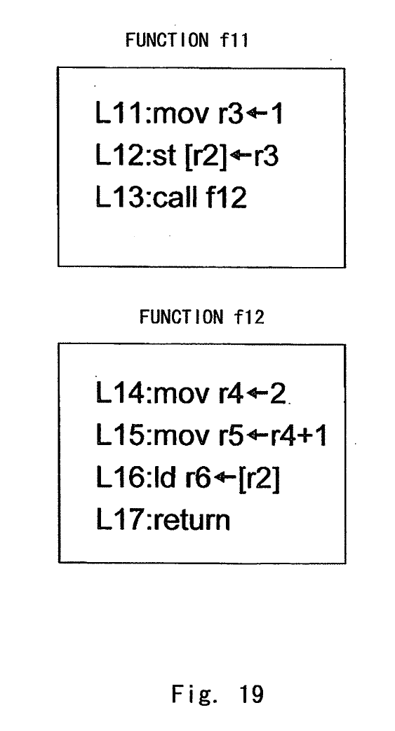

The specific example of the schedule processing and the dependency analysis shown in FIGS. 14 to 18 described above will be described with reference to FIGS. 19 to 24.

FIG. 19 is a diagram showing an input program before being converted to the sequential processing intermediate program. The input program is formed of the function f11 and the function f12, and the execution is started from the function f11. The function f11 calls for the function f12 by a function calling instruction L13.

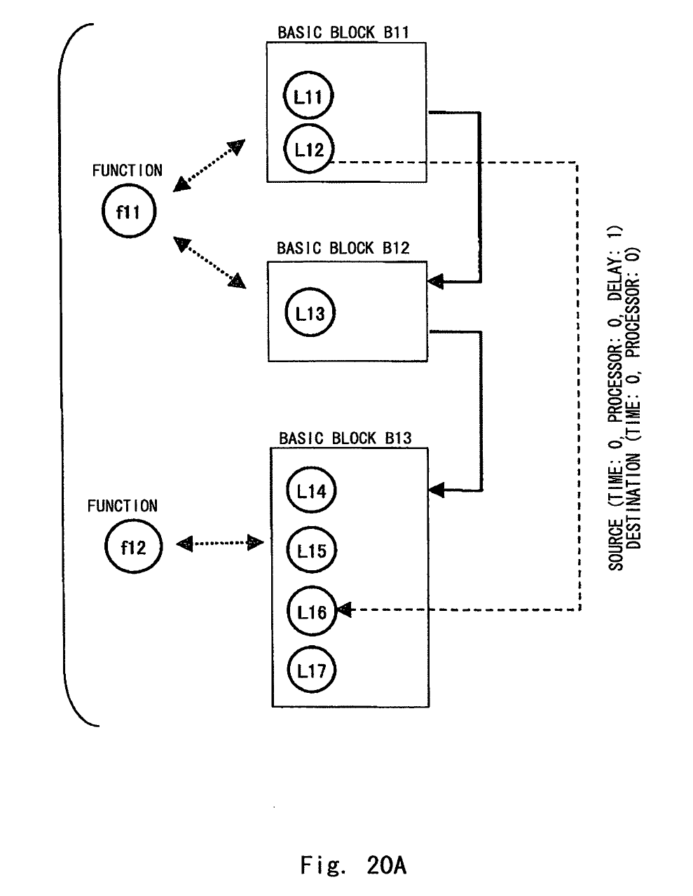

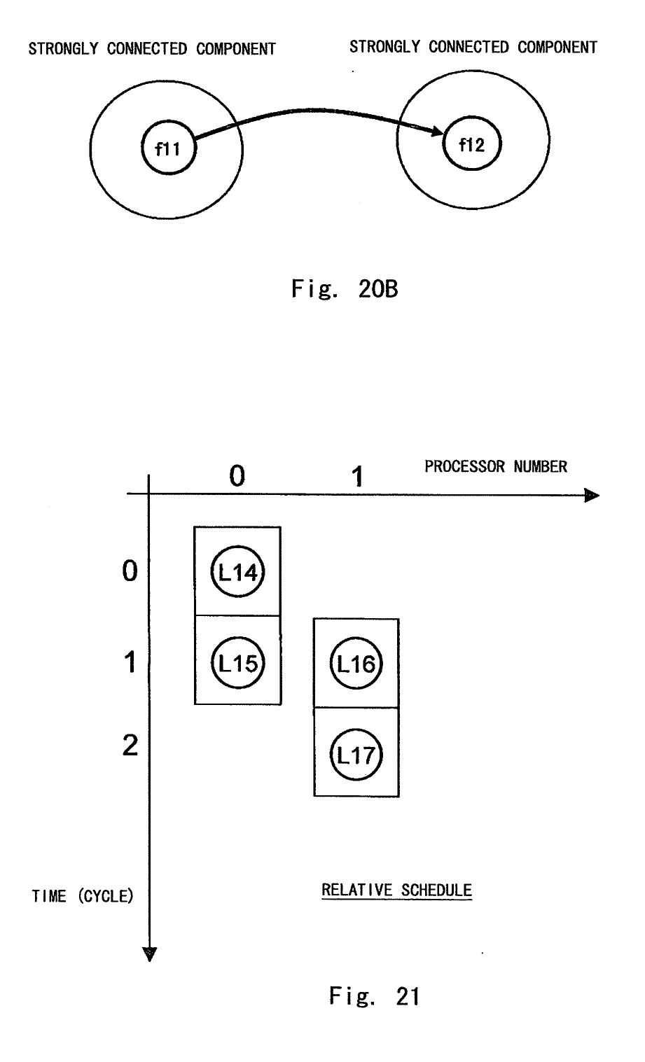

FIG. 20A is a diagram showing the sequential processing intermediate program, and FIG. 20B is a diagram showing the function calling graph of FIG. 20A. The function f11 and the function f12 are represented by the nodes indicating the functions. The function f11 is formed of the basic blocks B11 and B12, and this relation is shown by dotted arrows. The basic block B11 is formed of the instructions L11 and L12, and this relation is shown by surrounding them by a square. The basic block B12 is formed of the instruction L13. The function f12 is formed of the basic block B13, and the basic block B13 is formed of the instructions L14, L15, L16, and L17.

The control is moved to the basic block B12 after executing the basic block B11. After executing the function calling instruction L13 in the basic block B12, the control is moved to the basic block B13. This control flow will be shown by solid arrows. Further, in this example, as the instruction L16 needs to be executed after executing the instruction L12, the dependency by this data flow will be shown by a dashed arrow.

By analyzing the register data flow and the memory data flow, a directed side that shows the dependency of the data flow from the instruction L12 to the instruction L16 is created. It is assumed that the relative value of the execution time regarding the source added to the directed side of the dependency is zero, the relative value of the execution processor is zero, and the delay time is one, which is the delay time of the instruction L12. The relative value of the execution time regarding the destination is assumed to be zero, and the relative value of the execution processor is assumed to be zero.

As shown in FIG. 20B, the function calling graph is formed of the function f11 and the function f12, and there is a directed side from the function f11 to the function f12. Further, the function f11 forms one strongly connected component of the function calling graph by itself, and the function f12 also forms one strongly connected component by itself.

Next, the schedule processing and the dependency analysis with respect to the specific example shown in FIGS. 20A and 20B will be described with reference to the flow chart of FIGS. 14 to 18.

First, in step S101 of FIG. 14, the post-order of the function calling graph is the function f12 and the function f11, and each of them forms the strongly connected component by itself. Further, any strongly connected component is not selected. Accordingly, the strongly connected component that is formed of the function f12 is selected. In step S102, the function f12 is selected as the strongly connected component s that is selected is formed only of the function f12.

In step S103, the relative instruction schedule of the function f12 is executed. The term “relative schedule” means the schedule that indicates the increase amount from a basis which is the processor number and the execution cycle in which the function (function f12 in this example) has started execution.

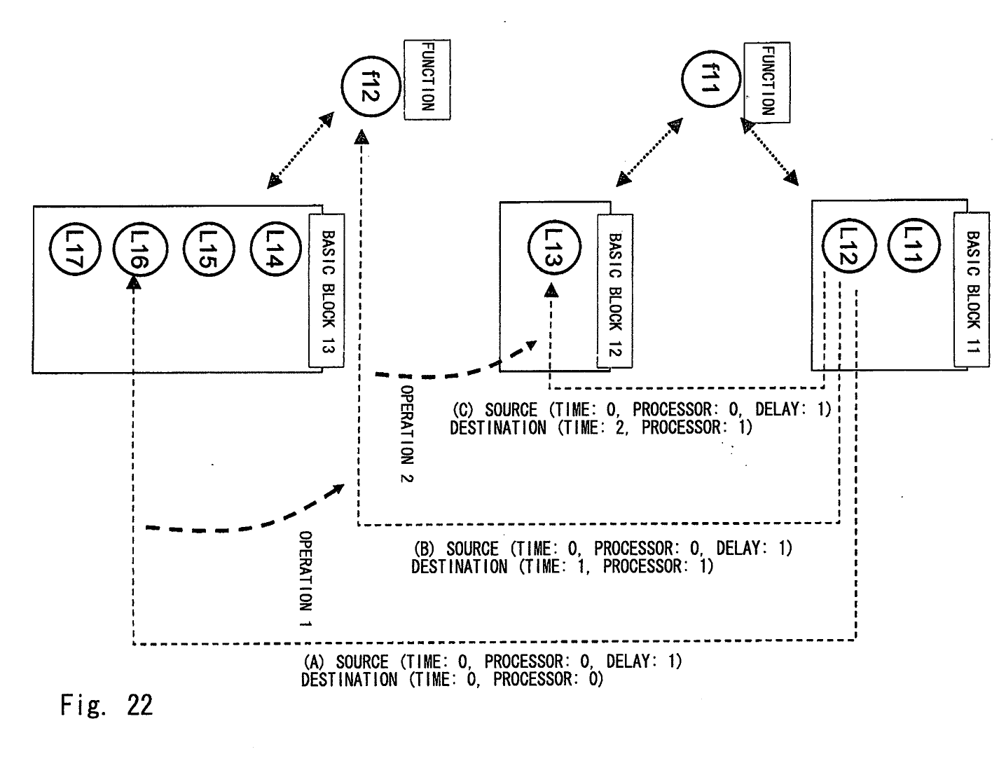

FIG. 21 is a diagram showing a relative schedule of the function f12. As a result of the relative scheduling in step S103, as shown in FIG. 21, the instruction L14 is arranged in (0,0), which is the cycle 0 and the processor 0, the instruction L15 is arranged in (1,0), which is the cycle 1 and the processor 0, the instruction L16 is arranged in (1,1), which is the cycle 1 and the processor 1, and the instruction L17 is arranged in (2,1), which is the cycle 2 and the processor 1. Now, arranging the instruction on the processor 1 means executing the instruction by a processor whose processor number is increased by one with a basis of the processor where the function has started the execution. The processor number here means the processor number of the schedule space. As the number of processors is limited, the residue that is obtained by dividing the processor number of the schedule space by the actual number of processors is used as the processor number in execution. Similarly, arranging the instruction in cycle 1 means executing the instruction one cycle later with a basis of the time (cycle) where the function has started the execution.

Since all the functions that form the strongly connected component have been scheduled in this example (Yes in step S104), the operation moves to step S105 to perform function internal/external dependency analysis regarding the source for each strongly connected component. In this example, the directed side of the dependency is not added in step S105, and thus, explanation will be omitted.

Next, in step S106, the function internal/external dependency analysis regarding the destination for each strongly connected component is performed. This point will be described with reference to FIGS. 17, 18, and 22.

FIG. 22 is a diagram showing a sequential processing intermediate program for describing the operation of the relative value added to the directed side in the dependency analyzing process.

First, as the strongly connected component that is selected is formed only of the function f12, the function f12 is selected in step S401 of FIG. 17. In step S402, the function internal/external dependency analysis regarding the destination for each function is performed.

As all the instructions of the function f12 are unselected in step S501 of FIG. 18, the control is made back to step S502, where the instruction L14 is selected. As there is no directed side of dependency where the instruction L14 is the destination in step S503, the control is moved back to step S501. Although the instruction L15 is selected in steps S501 and S502, there is no directed side of dependency where the instruction L15 is the destination as well, the control is moved back to step S501. Similarly, the instruction L16 is selected in steps S501 and S502.

As there is a directed side of the dependency which is the destination in the instruction L16, the directed side e of the dependency from the instruction L12 to the instruction L16 is selected in steps S503 and S504. Then, in step S505, the directed side e is duplicated to create the directed side of the dependency from the instruction L12 to the function f12.

Next, in step S506, the relative value of the execution processor number and the relative value of the execution time of the instruction L16 with a basis of the start time of the function f12 are added to the relative value regarding the destination added to the directed side. The relative values regarding the destination added to the directed side are zero for both of the execution time and the processor number as shown in FIG. 20A. As the relative value of the execution time of the instruction L16 is one and the relative value of the execution processor number is one as shown in FIG. 21, they are added. As a result, the operation op1 of FIG. 22 is executed, and the directed side of the dependency from the instruction L12 to the function f12 is created as shown in the dashed arrow (B). The relative value regarding the destination is (1, 1), which means the execution time is 1 and the execution processor is 1.

Next, in step S503, it is judged whether there is unselected one of the directed sides of the dependency where the instruction L16 is the destination. As there is no unselected one, the control is moved back to step S501. Then, the instruction L17 is selected in steps S501 and 5502. As there is no directed side of the dependency where the instruction L17 is the destination in step S503, the control is moved back to step S501. It is judged in step S501 whether there is an unselected instruction, and as there is no unselected instruction, the control is moved to step S507. In steps S507 and S508, the function calling instruction L13 that calls for the function f12 is selected.

Then, in steps S509 and S510, the directed side of the dependency from the instruction L12 to the function f12 is selected, and the directed side is duplicated to create the directed side of the dependency from the instruction L12 to the instruction L13 in step S511.

Next, in step S512, each of the relative value of the execution processor number and the relative value of the start time of the function f12 with a basis of the execution time of the instruction L13 is added to the relative value regarding the destination added to the directed side. In this example, it is assumed that the function f12 starts execution on the same processor one cycle later than the execution of the instruction L13, and thus, the execution processor 0 and the execution time 1 are added to the relative value (execution time 1, processor 1) regarding the destination added to the directed side. As a result, the operation op2 in FIG. 22 is executed, and the directed side of the dependency from the instruction L12 to the instruction L13 is created as shown by a dashed arrow (C). The relative value regarding the destination is (execution time 2, execution processor 1).

Next, in step S509, as there is no unselected one among the directed sides that are duplicated, the control is moved to step S507. As there is no unselected one among the function calling instructions that call for the function f12 in step S507, the function internal/external dependency analyzing processing regarding the destination for each function is completed.

Next, as all the functions of the strongly connected component that is formed of the function f12 have been searched in step S403 of FIG. 17, the operation is moved to step S404. It is judged whether the processing has been repeated for a specified number of times in step S404. As there is no function calling from the function f12 that forms the strongly connected component to the function that forms the same strongly connected component in this example, the specified count is set to 1. Accordingly, the function internal/external dependency analyzing processing regarding the destination for each strongly connected component is terminated.

Next, it is judged in step S107 of FIG. 14 whether the processing is repeated for a specified number of times. As the strongly connected component does not represent a loop, the specified count is 1, and the processing goes to step S109. After the strongly connected component that is formed of the function f12 is searched, and as the strongly connected component that is formed of the function f11 is not searched (No in step S109), the control is made back to step S101.

By executing the operations op1 and op2 shown in FIG. 22, the information of the dependency from the instruction L12 to the instruction L16 is embedded as the dependency from the instruction L12 to the instruction L13, as shown in a dashed arrow (C). Thus, the scheduling of the instruction L13 (calling instruction of function 12) is executed in view of the relative value (execution time 2, execution processor 1) regarding the instruction L16 which is the destination of dependency.

As the strongly connected component that is formed of the function f12 has been selected in step S101, the strongly connected component that is formed of the remaining function f11 is selected. As the selected strongly connected component is formed only of the function f11 in step S102, the function f11 is selected.

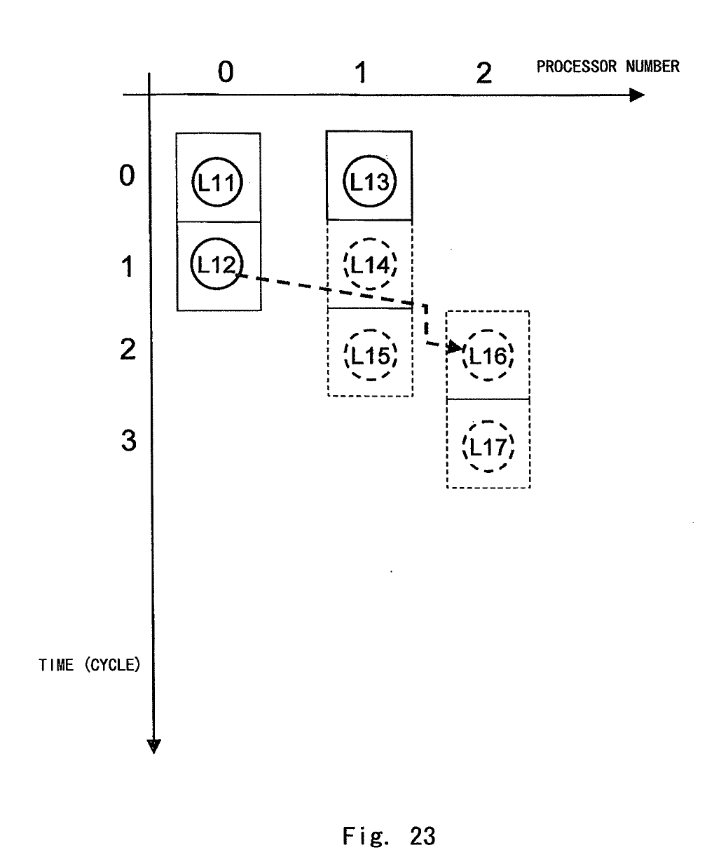

In step S103, the instruction schedule of the function f11 is executed. In the instruction schedule, as shown in FIG. 23, the instruction L11 and the instruction L12 have already been arranged, and L13 is to be arranged. Further, the data defined by the instruction L12 can be referred, one cycle later, from the instruction on the processor where the instruction L12 is executed or on another processor whose number is larger.

In determining the time and the processor in which the instruction L13 is arranged, the directed side of the dependency from the instruction L12 to the instruction L13 and the relative value (execution time 2, execution processor 1) added to the directed side are referred. The relative value regarding the source added to the directed side means the following point. That is, the data defined by the instruction L12 becomes available at a time obtained by adding the delay time and the relative time regarding the source to the execution time of the instruction L12 and on a processor in which the relative processor number regarding the source is added to the execution processor of the instruction L12.

Further, the relative value regarding the destination added to the directed side means the following point. That is, the instruction L16 that refers to the data is executed at a time obtained by adding the relative time regarding the destination to the execution time of the instruction L13 and on a processor in which the relative processor number regarding the destination is added to the execution processor of the instruction L13.

Accordingly, the data that is defined by the instruction L12 is made available in the cycle 2 in which the delay time 1 and the relative time 0 regarding the source are added to the cycle 1 where the instruction L12 is executed, and on a processor 0 in which the relative processor number 0 regarding the source is added to the processor 0 where the instruction L12 is executed.

Further, the instruction L16 is executed at a time in which the relative time 2 regarding the destination is added to the execution time of the instruction L13 and on a processor in which the relative processor number 1 regarding the destination is added to the execution processor of the instruction L13. It is only required that the execution time and the execution processor of the instruction L16 are the time and the processor in which the data defined by the instruction L12 can be obtained. It means that, in other words, it is only required that the time in which two is added to the execution time of the instruction L13 and the processor in which zero is added to the execution processor of the instruction L13 are equal to or larger than the cycle 2 and the processor number 0. Under such a condition, the instruction L13 is arranged at a time having the smallest execution time.

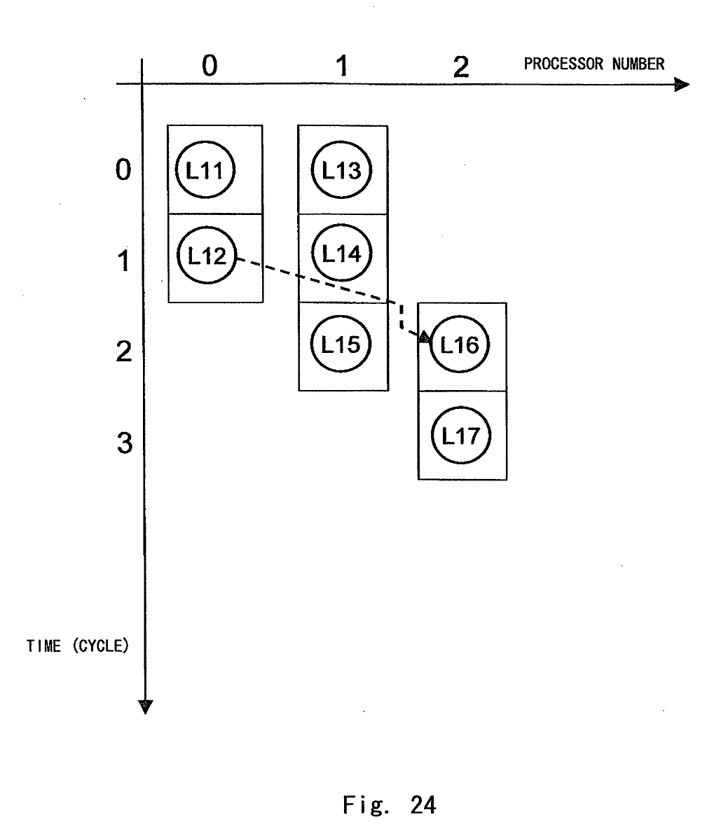

FIG. 23 is a diagram showing a schedule determination process of the instruction L13, and FIG. 24 is a schedule result of the instruction L13. As shown in FIG. 23, determining the arrangement of the instruction L13 means to determine the arrangement of the relative schedules of the instructions L13 to L17 that form the function f12 called by the instruction L13. Accordingly, the arrangement of the schedule of the instruction L13 may be determined in away that the instruction L16 which has dependency with the instruction L12 is in the execution cycle later than the instruction L12 (constraint condition a) and the whole execution time will be the shortest (constraint condition b). In this example, the arrangement of the instruction L13 that satisfies the conditions a and b will be the cycle 0 and the processor 1, as shown in FIG. 24.

By arranging the instruction L13 in the cycle 0 and the processor 1, execution of all the instructions is completed in four cycles.

### 3.6) Exemplary Advantage

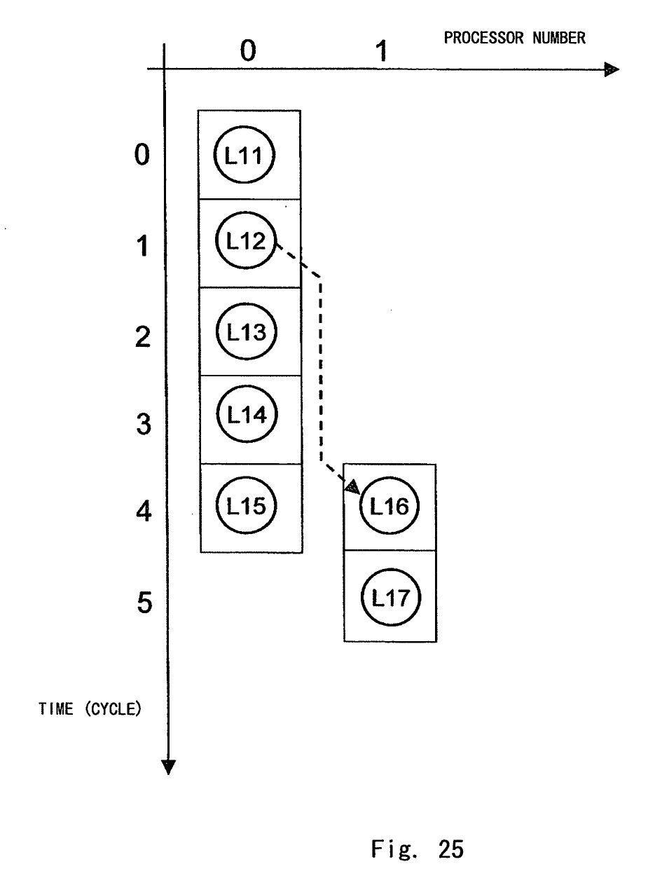

FIG. 25 is a diagram showing the schedule according to the related art as a comparative example. As such, when dependency between the instruction in one function f and the instruction of the function group of the descendant of the function f in the function calling graph is not considered, the safe approximation of the dependency from the instruction L12 to the instruction L16 is performed. To be more specific, the instruction L13 that calls for the function f12 including the instruction L16 is arranged at a time later than the execution time 1 of the instruction L12. If such an arrangement is performed, six cycles are required to execute all the instructions.

On the other hand, according to the first exemplary example, as the dependency between the instruction L12 in the function f11 and the instruction L16 in the function f12 that is called by the function f11 is analyzed, the execution time of the parallelization schedule according to the present invention can be made shorter. More specifically, the processor and the time in which the data defined by the instruction L12 can be obtained and the relative value that indicates how far the instruction L16 is deviated in execution from the execution time and the execution processor of the instruction L13 that calls for the function f12 are analyzed, and thereafter the execution time and the execution processor of the instruction L13 that calls for the function f12 are arranged using this analysis result. Accordingly, the execution time of the instruction L13 can be made earlier, and thus the start time of the function f12 can be made earlier.

Further, according to the first exemplary example, the search for the combination of the fork points is not performed in parallelization. Although it is difficult to speed up the program parallelization as the number of possible candidates of the combination of the fork points is extremely large, the searching of the combination of the fork points is not performed in this exemplary example, and thus the parallelized program with shorter parallel execution time can be generated in high speed.

### Example 2

### 4. Second Exemplary Example

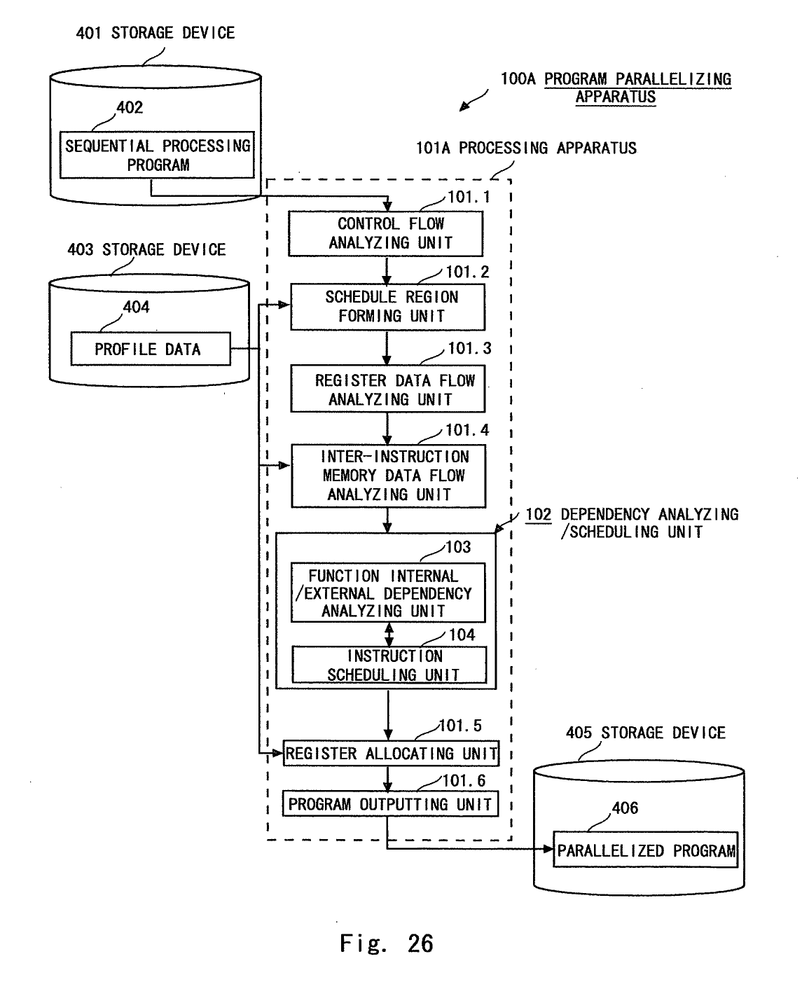

FIG. 26 is a schematic block diagram showing the configuration of a program parallelizing apparatus according to the second exemplary example of the present invention. A program parallelizing apparatus 100A according to the second exemplary example realizes the dependency analyzing/scheduling unit 102 that is equal to that of the first exemplary example by software or hardware in a processing apparatus 101A.

Further, in the second exemplary example, the control flow analyzing unit 101.1, the schedule region forming unit 101.2, the register data flow analyzing unit 101.3, and the inter-instruction memory data flow analyzing unit 101.4 described in FIG. 13 are provided, and the program parallelizing apparatus 100A outputs the inter-instruction dependency information 304 and the sequential processing intermediate program 302 to the dependency analyzing/scheduling unit 102. Further, the parallelization intermediate program output from the dependency analyzing/scheduling unit 102 is converted to the parallelized program 406 by the register allocating unit 101.5 and the program outputting unit 101.6.

In the storage device 401, the sequential processing program 402 having a machine instruction form generated by a sequential complier which is not shown is stored. In the storage device 403, a profile data 404 used in a process of converting the sequential processing program 402 to the parallelized program is stored. Further, the parallelized program 406 generated by the processing apparatus 101A is stored in the storage device 405. The storage devices 401, 403, and 405 are recording media such as magnetic disks or the like.

The program parallelizing apparatus 100A according to the second exemplary example receives the sequential processing program 402 and the profile data 404 to generate the parallelized program 406 for a multi-threading parallel processor. Such a program parallelizing apparatus 100A can be implemented by a program and a computer such as a personal computer and a work station. The program is recorded in a computer-readable recording medium such as a magnetic disk or the like, and read out by a computer when it is activated. By controlling the operation of the computer, the function means such as a control flow analyzing unit 101.1, a schedule region forming unit 101.2, a register data flow analyzing unit 101.3, an inter-instruction memory data flow analyzing unit 101.4, a dependency analyzing/scheduling unit 102, a register allocating unit 101.5, and a program outputting unit 101.6 is realized on the computer.

The control flow analyzing unit 101.1 receives the sequential processing program 402 and analyzes the control flow. The loop may be converted to the recursive function by referring to this analysis result. Each iteration of the loop may be parallelized by this conversion.

The schedule region forming unit 101.2 refers to the analysis result of the control flow by the control flow analyzing unit 101.1 and the profile data 404 to determine the schedule region which will be the target of the instruction schedule that determines the execution time and the execution processor of the instruction.

The register data flow analyzing unit 101.3 refers to the analysis result of the control flow and the determination of the schedule region by the schedule region forming unit 101.2 to analyze the data flow in accordance with the reading or writing of the register.

The inter-instruction memory data flow analyzing unit 101.4 refers to the analysis result of the control flow and the profile data 404 to analyze the data flow in accordance with the reading or writing of one memory address.

The dependency analyzing/scheduling unit 102 refers to, as described in the first exemplary example, the analysis result of the data flow of the register by the register data flow analyzing unit 101.3 and the analysis result of the data flow between instructions by the inter-instruction memory data flow analyzing unit 101.4, so as to analyze the dependency between instructions. Especially, the dependency analyzing/scheduling unit 102 analyzes the dependency between the instruction in one function and the instruction of the function group of the descendant of the function in the function calling graph. Then, as already stated, the dependency analyzing/scheduling unit 102 determines the execution time and the execution processor of the instruction according to the dependency, determines the execution order of the instruction to realize the execution time and the execution processor of the instruction that are determined, and inserts the fork command.

The register allocating unit 101.5 refers to the fork command and the execution order of instructions determined by the instruction scheduling unit 104 to allocate the register. The program outputting unit 101.6 refers to the result of the register allocating unit 101.5 to generate the executable parallelized program 406.

Next, the operation of the program parallelizing apparatus 100A according to the second exemplary example will be described. As the operation of the dependency analyzing/scheduling unit 102 has been described with reference to FIGS. 14 to 18, description thereof will be omitted.

First, the control flow analyzing unit 101.1 receives the sequential processing program 402 and analyzes the control flow. In the program parallelizing apparatus 101A, the sequential processing program 402 is represented by a form of graph, as is similar to the first exemplary example.

The schedule region forming unit 101.2 refers to the analysis result of the control flow by the control flow analyzing unit 101.1 and the profile data 404, and determines the schedule region which is the target of the instruction schedule that determines the execution time and the execution processor of instructions. The schedule region may be a basic block or may be a plurality of basic blocks, for example.

The register data flow analyzing unit 101.3 refers to the analysis result of the control flow and the determination of the schedule region by the schedule region forming unit 101.2, to analyze the data flow in accordance with the reading or writing of the register. The analysis of the data flow may be performed only in a function, or may be performed across functions. The data flow is represented by a directed side that connects the nodes representing the instructions as the inter-instruction dependency. As already described, the relative value of the execution time regarding the source, the relative value of the execution processor number, and the delay time of the instruction of the source are added to the directed side. At this point, the relative value of the execution time is set to zero, the relative value of the processor number is set to zero, and the delay time is set to the delay time of the instruction of the source. The relative value of the execution time regarding the destination and the relative value of the execution processor number are added to the directed side. At this point, the relative value of the execution time is set to zero and the relative value of the processor number is set to zero.

The inter-instruction memory data flow analyzing unit 101.4 refers to the analysis result of the control flow and the profile data 404, to analyze the data flow in accordance with the reading or writing with respect to one memory address. The data flow is shown by the directed side that connects the nodes indicating the instructions, as described above, as the inter-instruction dependency.

The register allocating unit 101.5 allocates the registers with reference to the fork command and the execution order of the instructions determined by the instruction scheduling unit 104. The program outputting unit 101.6 refers to the result of the register allocating unit 101.5 to generate the executable parallelized program 406.

As such, the inter-instruction dependency information may be generated on the processing apparatus 101A such as the program control processor or the like and the register is allocated to the parallelization intermediate program to output the executable parallelized program 406. As the dependency analyzing/scheduling unit 102 is included similarly to the first exemplary example, the parallelized program with shorter parallel execution time can be generated in high speed.

Note that the present invention is not limited to the above-described exemplary examples, but various additions or modifications can be made without changing the characteristics of the present invention. For example, the profile data 44 may be omitted in the second exemplary example.

### INDUSTRIAL APPLICABILITY

The program parallelizing method and the program parallelizing apparatus according to the present invention are applied to a method and an apparatus that generate parallel programs having high execution efficiency, for example.

1-32. (canceled)

33. A program parallelizing method that schedules a plurality of instructions for parallel processing, comprising:
analyzing inter-instruction dependency between an instruction of a first instruction group and an instruction of a second instruction group for a first instruction group including at least one of the instruction and a second instruction group including at least one of the instruction; and
executing instruction scheduling of the first instruction group and the second instruction group by referring to the inter-instruction dependency,
wherein executing instruction scheduling comprising executing instruction scheduling of the first instruction group and the second instruction group A) even when the first instruction group and the second instruction group are separated by function calling, B) by using distance relation of an execution time and an execution processor in the instruction dependency without approximating the distance relation by a unit of an instruction group.

34. The program parallelizing method according to claim 33, wherein when the first instruction group is correlated with a lower level of the second instruction group, the instruction scheduling of the first instruction group is executed, and thereafter the instruction scheduling of the second instruction group is executed by referring to the inter-instruction dependency.

35. The program parallelizing method according to claim 33, wherein the second instruction group includes a calling instruction that calls for the first instruction group.

36. The program parallelizing method according to claim 35, wherein information of the inter-instruction dependency is added to the calling instruction, and thereafter the instruction scheduling of the second instruction group is executed.

37. The program parallelizing method according to claim 33, wherein each of the first instruction group and the second instruction group forms a strongly connected component that includes at least one function including at least one instruction.

38. The program parallelizing method according to claim 37, comprising:
a) executing the instruction scheduling for each function included in one strongly connected component;
b) analyzing instruction dependency with another function for each function; and
c) repeating the a) and b) with respect to each strongly connected component for a predetermined number of times set in accordance with a form of the strongly connected component.

39. The program parallelizing method according to claim 38, wherein the form of the strongly connected component represents at least a case in which functions that form the strongly connected component execute mutual calling, a case in which one function forms the strongly connected component and the function executes self recursive call, or a case in which the strongly connected component represents a loop.

40. The program parallelizing method according to claim 38, wherein the b) is repeated for a predetermined number of times set in accordance with the form of the strongly connected component.

41. The program parallelizing method according to claim 40, wherein the form of the strongly connected component represents at least a case in which functions that form the strongly connected component execute mutual calling, a case in which one function forms the strongly connected component and the function executes self recursive call, or a case in which the strongly connected component represents a loop.

42. The program parallelizing method according to claim 41, wherein, when the form of the strongly connected component represents a loop and a repeat count of the loop is determined, the b) is repeated for a number of times that is equal to the repeat count of the loop.

43. The program parallelizing method according to claim 33, wherein the instruction scheduling of the first instruction group and the second instruction group is executed so as to maintain the inter-instruction dependency and make an execution time shortest.

44. A program parallelizing apparatus that schedules a plurality of instructions for parallel processing, comprising:
an inter-instruction dependency analyzing unit that analyzes inter-instruction dependency between an instruction of a first instruction group and an instruction of a second instruction group for a first instruction group including at least one instruction and a second instruction group including at least one instruction; and
the schedule unit refers to the inter-instruction dependency to determine an execution time and an execution processor of an instruction, and inserts a fork command in a position that realizes the execution time and the execution processor of the instruction that are determined,
wherein a schedule unit executes instruction scheduling of the first instruction group and the second instruction group A) even when the first instruction group and the second instruction group are separated by function calling, B) by using distance relation of an execution time and an execution processor in the instruction dependency without approximating the distance relation by a unit of an instruction group.

45. The program parallelizing apparatus according to claim 44, further comprising:
a control flow analyzing unit that analyzes a control flow of an input sequential processing program;
a schedule region forming unit that determines a region which is a schedule target by referring to an analysis result of the control flow;
a register data flow analyzing unit that analyzes a data flow of a register by referring to the schedule region; and
an inter-instruction memory data flow analyzing unit that analyzes dependency between an instruction to perform reading or writing on one address and an instruction to perform reading or writing from the address, wherein
the inter-instruction dependency analyzing unit analyzes dependency between an instruction in one function and an instruction of a function group of a descendent of the function in a function calling graph by referring to the register data flow and the inter-instruction memory data flow, and
the schedule unit refers to the inter-instruction dependency to determine an execution time and an execution processor of an instruction and inserts a fork command in a position that realizes the execution time and the execution processor of the instruction that are determined.

46. The program parallelizing apparatus according to claim 45, further comprising:
a register allocating unit that allocates a register by referring to a result of the schedule unit; and
a program outputting unit that generates an executable parallelized program by referring to a result of the register allocation.

47. The program parallelizing apparatus according to claim 44, wherein the inter-instruction dependency analyzing unit analyzes, for one instruction, a relative value of a processor and a relative value of a time in which the instruction defines or refers to data with a basis of a start time and an execution processor of a function of an ancestor on a function calling graph or a function to which the instruction belongs.

48. The program parallelizing apparatus according to claim 44, wherein the inter-instruction dependency analyzing unit analyzes, for one instruction, a relative value of a processor and a relative value of a time in which the instruction defines or refers to data with a basis of an execution processor and an execution time of an instruction that calls for a function of an ancestor on a function calling graph or a function to which the instruction belongs.

49. A program parallelizing method that receives a sequential processing intermediate program and outputs a parallelization intermediate program for a multi-threading parallel processor, the method comprising:
a) analyzing dependency between a function calling instruction and instructions of a function that is called in a function calling graph and of a function group of its descendant by referring to information of an analysis result of a data flow of a register and information of an analysis result of an inter-instruction dependency regarding one memory address;
b) determining an execution time and an execution processor of each instruction while referring to the inter-instruction dependency; and
c) inserting a fork command in a position that realizes the execution time and the execution processor of the instruction that are determined to output the parallelization intermediate program.

50. The program parallelizing method according to claim 49, wherein
the information of the analysis result of the data flow of the register is generated by analyzing the control flow of the input sequential processing program, determining a region of a schedule target by referring to the analysis result of the control flow, and analyzing a data flow of a register by referring to the region of the schedule target and the analysis result of the control flow, and
the information of the analysis result of the inter-instruction dependency regarding the memory address is generated by referring to the analysis result of the control flow and analyzing dependency between an instruction to perform reading or writing to one memory address and an instruction to perform reading or writing from the address.

51. The program parallelizing method according to claim 50, further comprising:
d) allocating a register by referring to an execution processor and an execution order of instructions that are determined; and
e) outputting a parallelized program by referring to a result of register allocation.

52. The program parallelizing method according to claim 49, wherein the step a) comprises:
a-1) a step of setting unselected one among strongly connected components of a function calling graph as a strongly connected component s in a specified order;
a-2) a step of setting unselected one among functions that form the strongly connected component s as a function f in a specified order;
a-3) a step of performing instruction schedule of the function f;
a-4) a step of judging whether all functions are scheduled and repeatedly executing the schedule if there is a function that is not scheduled;
a-5) a step of executing function in/out dependency analysis regarding a source of the strongly connected component s;
a-6) a step of executing function in/out dependency analysis regarding a destination of the strongly connected component s;
a-7) a step of judging whether the execution has been repeated for a specified count, and repeating the execution if the count number does not reach the specified count;
a-8) a step of setting all the functions that form the strongly connected component s as unselected; and
a-9) a step of judging whether all strongly connected components have been searched, and repeatedly executing search if there is a strongly connected component that is not searched.

53. The program parallelizing method according to claim 52, wherein the step a-5) comprises:
a-5-1) a step of setting an unselected function among functions that form the strongly connected component as a function f in a specified order;
a-5-2) a step of executing function in/out dependency analysis regarding a source of the function f;
a-5-3) a step of judging whether all functions are searched, and repeatedly executing search if there is a function that is not searched;
a-5-4) a step of judging whether the execution has been repeated for a specified count, and repeating the execution if the count number does not reach the specified count; and
a-5-5) a step of setting all the functions that form the strongly connected component as unselected.

54. The program parallelizing method according to claim 53, wherein the step a-5-2) comprises:
a-5-2-1) a step of judging whether there is an unselected instruction among instructions of a function of a processing target, and repeatedly executing selection if there is an unselected instruction;
a-5-2-2) a step of setting an unselected one of the instructions as an instruction i in a specified order;
a-5-2-3) a step of repeatedly executing selection when there is an unselected one among directed sides of dependency in which the instruction i is a source;
a-5-2-4) a step of setting an unselected one among the directed sides as a directed side e in a specified order;
a-5-2-5) a step of duplicating the directed side e and setting a source as a node representing a function;
a-5-2-6) a step of adding relative values of an execution processor number and an execution time of the instruction i with a basis of a start time of a function to a relative value regarding the source added to the directed side;
a-5-2-7) a step of repeatedly executing selection when there is an unselected one among function calling instructions that call for a function,
a-5-2-8) a step of setting an unselected one among the instructions as a function calling instruction c in a specified order;
a-5-2-9) a step of repeatedly executing selection if there is an unselected one among directed sides that are duplicated;
a-5-2-10) a step of setting an unselected one among the directed sides as a directed side e in a specified order;
a-5-2-11) a step of duplicating the directed side e and creating a directed side in which a source of a directed side which is duplicated is set to an instruction c; and
a-5-2-12) a step of adding relative values of an execution processor number and a start time of a function with a basis of an execution time of a function calling instruction to a relative value regarding a source added to a directed side.

55. The program parallelizing method according to claim 52, wherein the step a-6) comprises:
a-6-1) a step of setting an unselected function among functions that form the strongly connected component as a function f in a specified order;
a-6-2) a step of executing function in/out dependency analysis regarding a destination for each function;
a-6-3) a step of judging whether all functions are searched and repeatedly executing search if there is a function that is not searched;
a-6-4) a step of judging whether the execution has been repeated for a specified count, and repeating the execution if the count number does not reach the specified count; and
a-6-5) a step of setting all the functions that form the strongly connected component to unselected.

56. The program parallelizing method according to claim 55, wherein the step a-6-2) comprises:
a-6-2-1) a step of judging whether there is an unselected instruction among instructions of a function of a processing target and repeatedly executing selection if there is an unselected instruction;
a-6-2-2) a step of setting an unselected one among the instructions as an instruction i in a specified order;
a-6-2-3) a step of repeatedly executing selection when there is an unselected one among directed sides of dependency where the instruction i is a destination;
a-6-2-4) a step of setting an unselected one of the directed sides as a directed side e in a specified order,
a-6-2-5) a step of duplicating the directed side e and setting a destination as a node that represents a function;
a-6-2-6) a step of adding relative values of an execution processor number and an execution time of the instruction i with a basis of a start time of a function to a relative value regarding the destination added to the directed side;
a-6-2-7) a step of repeatedly executing selection when there is an unselected one among function calling instructions that call for a function;
a-6-2-8) a step of setting an unselected one of the instructions as a function calling instruction c in a specified order;
a-6-2-9) a step of repeatedly executing selection if there is an unselected one among directed sides that are duplicated;
a-6-2-10) a step of setting an unselected one of the directed sides as a directed side e in a specified order;
a-6-2-11) a step of duplicating the directed side e and setting a destination of a directed side which is duplicated to an instruction c; and
a-6-2-12) a step of adding relative values of an execution processor number and a start time of a function with a basis of an execution time of a function calling instruction to a relative value regarding a destination added to a directed side.

57. The program parallelizing method according to claim 49, comprising, in the step a), for one instruction, analyzing a relative value of a processor and a relative value of a time in which the instruction defines or refers to data with a basis of an execution processor and a start time of a function of an ancestor on a function calling graph or a function to which the instruction belongs.

58. The program parallelizing method according to claim 49, comprising, in the step a), for one instruction, analyzing a relative value of a processor and a relative value of a time in which the instruction defines or refers to data with a basis of an execution processor and an execution time of an instruction that calls for a function of an ancestor on a function calling graph or a function to which the instruction belongs.

59. A recording medium that stores a program for causing a computer that forms a program parallelizing apparatus that schedules a plurality of instructions for parallel processing to operate as:
an inter-instruction dependency analyzing unit that analyzes inter-instruction dependency between an instruction of a first instruction group and an instruction of a second instruction group for a first instruction group including at least one of the instruction and a second instruction group including at least one of the instruction; and
a schedule unit that executes instruction scheduling of the first instruction group and the second instruction group by referring to the inter-instruction dependency,
wherein a schedule unit executes instruction scheduling of the first instruction group and the second instruction group A) even when the first instruction group and the second instruction group are separated by function calling, B) by using distance relation of an execution time and an execution processor in the instruction dependency without approximating the distance relation by a unit of an instruction group.

60. The recording medium that stores the program according to claim 59, wherein the program further causes the computer to operate as:
a control flow analyzing unit that analyzes a control flow of an input sequential processing program;
a schedule region forming unit that determines a region which is a schedule target by referring to an analysis result of the control flow;
a register data flow analyzing unit that analyzes a data flow of a register by referring to the schedule region; and
an inter-instruction memory data flow analyzing unit that analyzes dependency between an instruction to perform reading or writing on one address and an instruction to perform reading or writing from the address, wherein
the inter-instruction dependency analyzing unit analyzes dependency between an instruction in one function and an instruction of a function group of a descendent of the function in a function calling graph by referring to the register data flow and the inter-instruction memory data flow, and
the schedule unit refers to the inter-instruction dependency to determine an execution time and an execution processor of an instruction and inserts a fork command in a position that realizes the execution time and the execution processor of the instruction that are determined.

61. The recording medium that stores the program according to claim 60, wherein the program further causes the computer to operate as:
a register allocating unit that allocates a register by referring to a result of the schedule unit; and
a program outputting unit that generates an executable parallelized program by referring to a result of the register allocation.

62. The recording medium that stores the program according to claim 59, wherein the inter-instruction dependency analyzing unit analyzes, for one instruction, a relative value of a processor and a relative value of a time in which the instruction defines or refers to data with a basis of a start time and an execution processor of a function of an ancestor on a function calling graph or a function to which the instruction belongs.

63. The recording medium that stores the program according to claim 59, wherein the inter-instruction dependency analyzing unit analyzes, for one instruction, a relative value of a processor and a relative value of a time in which the instruction defines or refers to data with a basis of an execution processor and an execution time of an instruction that calls for a function of an ancestor on a function calling graph or a function to which the instruction belongs

64. The recording medium that stores the program for causing a computer that forms a program parallelization apparatus that receives a sequential processing intermediate program and outputs a parallelization intermediate program for a multi-threading parallel processor to operate as:
a function in/out dependency analyzing unit that analyzes dependency between an instruction in one function and an instruction of a function group of its descendant of the function in a function calling graph by referring to an analysis result of inter-instruction dependency; and
an instruction schedule unit that determines an execution time and an execution processor of an instruction by referring to the analysis result of the function in/out dependency analyzing unit, and inserts a fork command in a position that realizes the execution time and the execution processor of the instruction that are determined to output the parallelization intermediate program.
